(19) United States
(12) Patent Application Publication
(10) Pub. No.: US 2003/0055640 A1
(43) Pub. Date: Mar. 20, 2003

(54) System and method for parameter estimation for pattern recognition

(75) Inventors: David Burshtein, Herzliya (IL); Assaf Ben-Yishai, Ramat Hasharon (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: RAMOT UNIVERSITY AUTHORITY FOR APPLIED RESEARCH & INDUSTRIAL DEVELOPMENT LTD.

(21) Appl. No.: 10/134,451

(22) Filed: Apr. 30, 2002

Related U.S. Application Data
(60) Provisional application No. 60/287,385, filed on May 1, 2001.

(51) Int. Cl. G10L 15/26

(52) U.S. Cl. 704/235

(57) ABSTRACT

A parameter estimator for estimating a set of parameters for pattern recognition has a recognizer for receiving a training set having members. The recognizer performs recognition on the members of the training set using a current set of parameters and based upon a predetermined group of elements. A set generator associated with the recognizer generates at least one equivalence set containing recognized members of the training set, which are used by a target function determiner associated with the set generator to calculate a target function using the set of parameters. A maximizer updates the parameter set so as to maximize the calculated target function.

### FIELD OF THE INVENTION

The present invention relates to parameter estimation for pattern recognition and more particularly but not exclusively to parameter estimation for statistical models with incomplete data.

### BACKGROUND OF THE INVENTION

Statistical pattern recognition is used in many fields, and plays a large role in speech recognition processing. The basic principles of automatic speech recognition have been known since the 1970's. However, speech recognition technology became more accessible in the 1990's, mainly due to the development of faster, smaller, and cheaper processors.

Variability in pronunciation due to different accents, dialects, speaking rates, and other factors makes the recognition of human speech, though trivial for a human being, a very difficult task for a computer. Due to these difficulties the performance of state of the art speech recognition systems is still far from being optimal, and the development of new and improved tools is a challenging field for scientific research.

Reference is now made to FIG. 1, which illustrates the structure of a typical hidden Markov model (HMM) speech recognizer. The hidden Markov model is one of the predominant tools in automatic speech recognition. A/D converter 110 samples the speech signal and converts the signal from analog to digital. The output of the A/D converter is a sample vector containing a sequence of samples representing the speech waveform. The purpose of feature extractor 120 is to convert the speech samples to a form that is easier for processing by the rest of the speech recognition system. Feature extraction is generally done by dividing the speech samples into frames and extracting a feature vector from each frame. The dimension of the features is smaller than the dimension of the original samples, but the feature vectors are assumed to contain almost as much information as the sample vector about the speech transcription. The Viterbi recognizer 130 is the core of the recognition system. The input to the recognizer is the sequence of feature vectors and its output is the transcription. The recognition is performed according to a language model and an acoustic model. The language model 140 imposes grammatical constraints on the transcription. Discarding illegal transcriptions and taking into account the probability of legal ones can enhance the system's performance. The acoustic model 150 models the relation between the feature space and the linguistic units. The relation determined by the acoustic model is embedded in a HMM that is attributed to each linguistic unit. The acoustic information of each linguistic unit is embedded in the HMM parameters. Training processor 160 sets the HMM parameters according to the given training data. The training data consists of utterances of the linguistic units, according to which the system learns the model parameters.

Speech recognition using HMMs can be regarded as a statistical pattern recognition problem. First, the speech signal is sampled, divided into frames, and a feature vector is extracted from each frame according to which recognition is performed. Features can be linear predictive codes, mel frequency cesptrum coefficients, log spectrum, etc. The feature vector is denoted by oₜ([oₜ]₁, . . . , [oₜ]ₙ)′ and the sequence of feature vectors that comprises the utterance is denoted by O=(o₁, . . . , o_{T}). Assume that O corresponds to a transcription comprised of a sequence of linguistic units. These linguistic units can be words, or sub-word units (such as phones, triphones etc.). The transcription is denoted by w=(w¹, . . . , w^{U}). Each word w^{u} belongs to a known vocabulary of V words which forms the set {1, . . . , V}.

The principle assumption in the statistical approach to speech recognition is that each word v is characterized by a probability density function (pdf) p(O|v). These functions are the acoustic model. It is also assumed that w corresponds to the probability function p(w) which is the language model. The goal of the recognition task is to decode the transcription ŵ of the utterance O. According to Bayes decision theory, when assigning an equal cost to all recognition errors and a zero cost to correct recognition, the decision rule that yields the minimum error rate is the MAP criterion:

$$\hat{w} = arg {max}_{w} p ( w / O )$$

Applying Bayes' Rule, bearing in mind that p(O) is independent of w, the decision rule becomes:

$$\hat{w} = arg {max}_{w} p ( O , w ) = p ( O / w ) p ( w )$$

The common choice for the conditional pdf's, p(O|v), is that of a hidden Markov model (HMM). The HMM can be defined as a parametric pdf, in the following manner. Let p_{θ}(O|v) denote a parametric pdf corresponding to a HMM, where θ denotes the entire parameter set of all models. The notation p_{θ}(.) denotes the probability or pdf p(.) as calculated using parameters taken from the set θ.

Assume that there exists an underlying state sequence s that produces the observation sequence O. Let p_{θ}(s)=p_{θ}(s₀, . . . , s_{T+1}), be the probability of the state sequence s. Assume as well that the state sequence s has a first order Markovian distribution, i.e. p_{θ}(sₜ|s₀, . . . , sₜ₋₁)=p_{θ}(sₜ|sₜ₋₁). Then:

$${p}_{0} ( s ) = {\prod }_{t = 0}^{T} {p}_{θ} ( {s}_{i + 1} \vert {s}_{t} )$$

The states s₀, . . . , s_{T+1}, belong to the set {1, . . . , N}, and s₀ and s_{T+1} are constrained to be 1 and N respectively. States 1 and N are the entry and exit non-emitting states of the model and are constrained to appear only in the beginning and the end of the state sequence respectively. Defining the transition probabilities:

aᵢⱼ=p(sₜ₊₁=j|sₜ=i) 1≦i, j≦N

where

$${\sum }_{j = 1}^{N} {a}_{ij} = 1.$$

Note that, due to the constraints on the non-emitting states: aᵢ₁=0, and a_{Nj}=0. Assume that for 1≦t≦T, oₜ, the observation at time t, is drawn according to the pdf corresponding to sₜ, the state at time t. These pdf's are denoted by:

bᵢ(oₜ)=p(oₜ|sₜ=i)

States 1 and N do not have pdf's and are not linked to observations, and therefore are referred to as non-emitting. The joint probability of s and O is:

$${p}_{θ} ( s , O \vert v ) = \{ {\prod }_{t - 0}^{T} {a}_{{s}_{t} {s}_{t + 1}} \} \{ {\prod }_{t = 1}^{T} {b}_{{s}_{t}} ( {o}_{t} ) \} .$$

So, the probability of the utterance O is:

$$\begin{matrix}{p}_{0} ( O \vert v ) = {\sum }_{s ∈ v} {p}_{θ} ( s , O \vert v ) \\ = {\sum }_{s ∈ v} \{ {\prod }_{t = 0}^{T} {a}_{{s}_{t} {s}_{t + 1}} \} \{ {\prod }_{t = 1}^{T} {b}_{{s}_{t}} ( {o}_{t} ) \}\end{matrix}$$

where the notation sεv denotes all possible state sequences of the word v.

Many choices are possible for the functions bᵢ(.). The bᵢ(.) functions can be either continuous pdf's, or discrete probability functions. The bᵢ(.) are often chosen to be Gaussian mixture pdf's, namely:

$${b}_{i} ( {o}_{t} ) = {\sum }_{k = 1}^{K} {c}_{ik} {b}_{ik} ( {o}_{t} )$$

where cᵢₖ are the mixture weights, and

$${\sum }_{k - 1}^{K} {c}_{ik} = 1 ,$$

and where bᵢₖ(.), are Gaussian vector pdf's:

$${b}_{ik} ( {o}_{t} ) = \frac{I}{\sqrt{{( 2 π )}^{n} \vert {Λ}_{ik} \vert}} exp ( - \frac{1}{2} {( {o}_{t} - {μ}_{ik} )}^{′} {Λ}_{ik}^{- 1} ( {o}_{t} - {μ}_{ik} ) ) .$$

μᵢₖ=(μᵢₖ₁, . . . , μᵢₖₙ)′ is the mean vector, and Λᵢₖ is the covariance matrix. For simplicity, Λᵢₖ can be chosen to be diagonal matrices:

Λᵢₖ=diag(σᵢₖ₁², . . . , σᵢₖₙ²).

In summary, the HMM parameter set consists of the following elements:

aᵢⱼ, the transition probability from state i to state j,

$${\sum }_{j = 1}^{N} {a}_{ij} = 1.$$

cᵢₖ, the weight of the k^{th} mixture of the i^{th} state,

$${\sum }_{k = 1}^{K} {c}_{ik} = 1.$$

μᵢₖ, the mean vector of the k^{th} mixture of the i^{th} state.

Λᵢₖ=diag{σᵢₖ₁², . . . , σᵢₖₙ²}, the diagonal covariance matrix of the k^{th} mixture of the i^{th} state.

The entire parameter set of all the words in the vocabulary is denoted by θ.

The objective of the training task is to estimate the parameter set θ of the statistical model. Parameter estimation is performed using a training set. The training set consists of the utterances O=(O¹, . . . , O^{U}), and their corresponding transcription W=(w¹, . . . , w^{U}). Maximum Likelihood (ML) estimation aims to maximize the likelihood of the utterances given their corresponding transcription. So the estimation process is basically the optimization of the objective function L(θ) with respect to θ, where:

L(θ)=log p_{θ}(O|W).

Defining the following sets of indices:

$${A}_{v} {△}_{=} \{ u \vert {w}^{u} = v \}$$

yields:

$$L ( θ ) = {\sum }_{u = 1}^{U} log {p}_{θ} ( {O}^{u} \vert {w}^{u} ) = {\sum }_{v - 1}^{V} {\sum }_{u ∈ Av} log {p}_{θ} ( {O}^{u} \vert {w}^{u} ) {△}_{=} {\sum }_{v = 1}^{V} {L}_{v} ( θ ) .$$

Notice that Lᵥ(θ) is a function that consists only of the pronunciations of the word v and the word's corresponding parameter set. The estimation task is thus reduced to maximizing each function Lᵥ(θ) with respect to the parameters of v. Due to the complex nature of these objective functions in the HMM case, there are no explicit formulas for a direct calculation of the parameters. The commonly used iterative solution to the maximization problem is known as the Baum-Welch Algorithm. The Baum-Welch algorithm was shown to be a special case of the EM (Expectation-Maximization or Estimate-Maximize) algorithm, introduced by Dempster Laird and Rubin in 1977.

The EM Algorithm is as follows. Let x be the complete data with the parametric pdf f_{X}(x;θ), and let y=H(x) be the incomplete data with the parametric pdf f_{Y}(y;θ) where H(.) is a non-invertible (many-to-one) transformation. The goal is to find the ML estimate \hat{θ}=arg max_{θ} f_{Y}(y;θ), however it is much more convenient to maximize f_{X} (x;θ) with respect to θ. Let:

f_{X}(x;θ)=f_{Y}(y;θ)f_{X|Y}(x|y;θ) ∀ x,y|H(x)=y

so that:

log f_{Y}(y;θ)=log f_{X}(x;θ)−log f_{X|Y}(x|y;θ) ∀ x,y|H(x)=y

Now, taking the conditional expectation using the parameter set θ′, E_{θ′}(.|y), from both sides:

$$\begin{matrix}log {f}_{γ} ( y ; θ ) = {E}_{{θ}^{′}} \{ log fx ( x ; θ \vert y \} - {E}_{{θ}^{′}} \{ log {f}_{X \vert Y} ( x \vert y ; θ ) \vert y \} \\ = Q ( θ , {θ}^{′} ) - H ( θ , {θ}^{′} )\end{matrix}$$

where Q(.,.) is called the auxiliary function of the algorithm. Observe that:

$$\begin{matrix}H ( {θ}^{′} , {θ}^{′} ) - H ( θ , {θ}^{′} ) = {E}_{{θ}^{′}} ( log \frac{{}^{f} X \vert {Y}^{( x \vert y ; {θ}^{′} )}}{{}^{f} X \vert {Y}^{( x \vert y ; θ )}} \vert y ) \\ = D ( {}^{f} X \vert {Y}^{( x \vert y ; {θ}^{′} ) ‖ f} X \vert {Y}^{( x \vert y ; θ )} ) \geq 0\end{matrix}$$

where D (f∥g) represents the Kullback-Leibler distance between the densities f and g, which is always non-negative. Therefore: Q(θ,θ′)>Q(θ′,θ′) implies that log f_{Y}(y;θ)>log f_{Y}(y;θ′). Considering the result, gives the following iterative algorithm:

E-step Compute:

Q(θ,θ^{(l)})

M-step Maximize:

θ^{(l+1)}=arg max_{θ}Q(θ,θ^{(l)})

Each iteration increases the likelihood. It is also possible to show that the algorithm converges to a stationary point, that is to a local maximum of the likelihood function.

The EM algorithm can be applied to the HMM case. The resulting re-estimation formulas for the parameters of the word v are:

$$\begin{matrix}{\overline{a}}_{ij} = \frac{{\sum }_{u ∈ {A}_{v}} {\sum }_{t = 0}^{{T}^{u}} {p}_{θ} ( {s}_{t} = i , {s}_{t + 1} = j \vert {O}^{u} , v )}{{\sum }_{u ∈ {A}_{v}} {\sum }_{t - 0}^{{T}^{u}} {ψ}_{l}^{u} ( t )} \\ {\overline{c}}_{ik} = \frac{{\sum }_{u ∈ {A}_{v}} {\sum }_{t = 1}^{{T}^{u}} {ψ}_{ik}^{u} ( t )}{{\sum }_{u ∈ {A}_{v}} {\sum }_{t = 1}^{{T}^{u}} {ψ}_{l}^{u} ( t )} \\ {\overline{μ}}_{ikj} = \frac{{\sum }_{u ∈ {A}_{v}} {\sum }_{t = 1}^{{T}^{u}} {[ {o}_{t}^{u} ]}_{j} {ψ}_{ik}^{u} ( t )}{{\sum }_{u ∈ {A}_{v}} {\sum }_{t = 1}^{{T}^{u}} {ψ}_{ik}^{u} ( t )} \\ {\overline{σ}}_{ikj}^{2} = \frac{{\sum }_{u ∈ {A}_{v}} {\sum }_{t = 1}^{{T}^{u}} {ψ}_{ik}^{u} ( t ) {( {[ {o}_{t}^{u} ]}_{j} - {\overline{μ}}_{ikj} )}^{2}}{{\sum }_{u ∈ {A}_{v}} {\sum }_{t = 1}^{{T}^{u}} {ψ}_{ik}^{u} ( t )}\end{matrix}$$

where:

ψᵢₖ^{u}(t)=p_{θ}(sₜ=i, gₜ=k|O^{u}, v),

ψᵢ^{u}(t)=p_{θ}(sₜ=i|O^{u}, v),

and gₜ is the index of the Gaussian mixture at time t.

Due to the constraint s₀=1 and s_{T+1}=N, the equation for \overline{a}ᵢⱼ also serves for the calculation of a₁ⱼ and a_{1N}. The terms in the equations for ψ^{u}ᵢₖ(t) and ψ^{u}ᵢ(t), as well as the term p_{θ}(sₜ=i, sₜ₊₁=j|O^{u},v) in the equation for \overline{a}ᵢⱼ can be efficiently calculated using the so-called Forward-Backward algorithm known in the art.

Observing the above equations, it is possible to see that for an arbitrary HMM parameter b, the re-estimation formula takes the form:

$$\overline{b} = \frac{N ( b )}{D ( b )}$$

where N(b) and D(b) are calculated using the observations in set Aᵥ, and are referred to as the accumulators.

As shown above, it is possible to solve the isolated word recognition problem. For the isolated word recognition problem, the assumption is that the utterance O corresponds to the pronunciation of a single word w, and that p(w), the language model (which in the word recognition case consists only of the prior probabilities of the words), is known in advance. p(O|w) can be calculated using the Forward Backward algorithm, so it is possible to perform recognition using the MAP criterion.

In practice, however, it is preferable to use an approximate algorithm that is more conveniently generalized to the case of continuous speech recognition. The following approximation is used:

$${p}_{θ} ( O \vert v ) = {\sum }_{s ∈ v} {p}_{θ} ( s , O \vert v ) \approx {max}_{s} {p}_{θ} ( s , O \vert v ) {△}_{=} {\hat{p}}_{θ} ( O \vert v )$$

The approximated term can be calculated using the Viterbi algorithm. Denote by φᵢ(t) the joint probability of the observation sequence o₁, . . . , oₜ and the states sequence s₀, . . . , sₜ=i that yields the maximal likelihood. The following recursion is used:

φᵢ(t)=maxⱼ{φⱼ(t−1)aⱼᵢ}bᵢ(oₜ)

with the initial condition:

φ₁(1)=1 for i=1

φᵢ(1)=a₁ᵢbᵢ(o₁) for 1<i<N

so:

\hat{p}_{θ}(O|v)−φ_{N}(T)=maxⱼ{φⱼ(T)a_{jN}}

The above algorithm can be generalized to the case of continuous speech recognition. The generalization is done by assuming a language model of the form of a first order Markovian model. It is thus possible to regard the entire set of HMM states of the entire vocabulary as single composite HMM. According to the HMM model thus obtained, the transition probabilities between words are the transition probabilities between the exit non-emitting state of one word to the entry non-emitting state of another word. Using the composite HMM, it is possible to apply the Viterbi algorithm with a few minor modifications, that take into account the non-emitting states and the transitions between words.

The above discussion describes methods for performing statistical pattern recognition while estimating the parameter by the ML method. However, the estimation method described above suffers from several shortcomings. Alternate parameter estimation methods known in the art, such as Maximum Mutual Information (MMI), Corrective Training, and Minimum Classification Error (MCE), are discussed below. These alternate training methods may address some of these shortcomings.

Maximum Likelihood (ML) estimation is one of the predominant techniques in the field of parameter estimation. It is also a prevalent training technique in the field of statistical speech recognition, and in the field of statistical pattern recognition in general. In the scenario described above, the ML objective function is:

$$L ( θ ) = log {p}_{θ} ( O \vert W ) = {\sum }_{u = 1}^{U} log {p}_{θ} ( {O}^{u} \vert {w}^{u} )$$

The training task is therefore to maximize the objective function L(θ) with respect to the parameter set 0.

The following attribute of the ML estimate is well known from the theory of parameter estimation: The ML estimate is asymptotically unbiased and efficient, i.e. for a large sample set, the error in the estimation of the parameters tends to be distributed with zero mean and a covariance matrix equal to the Cramér-Rao lower bound. The ML estimate is also known to be normally distributed. So, in a statistical pattern recognition problem, when the training set is sufficiently large, the ML estimate converges to the real value of the parameters, thus the ML estimate enables achieving the true probabilities of the classes and the optimal decision rule.

In the problem of speech recognition using HMMs the ML estimate has another benefit, which is the simplicity of its calculation using the Baum-Welch algorithm.

Unfortunately, the true distribution of the speech signal cannot be modeled by a HMM, and in a realistic situation the training data is usually sparse. Hence, the HMM parameters do not embed statistical characteristics, and the objective of minimizing the error in the parameter estimates can be replaced by a different one. Observing the speech recognition problem from a different angle, the HMM pdf's can be regarded as discriminant functions, i.e. functions according to which classification is made. Regarding th HMM pdf's as discriminant functions, a more appropriate objective can be to design the pdf's in such a way that would minimize the recognition error rate on the training set. Recalling the ML objective function:

$$L ( θ ) = {\sum }_{v = 1}^{V} {\sum }_{u ∈ {A}_{v}} log {p}_{θ} ( {O}^{u} \vert {w}^{u} ) = {\sum }_{v = 1}^{V} {L}_{v} ( θ )$$

Assuming that the parameter set of each word is distinct, it is evident that the ML estimation can be performed by estimating the parameters of each word separately, according to its correspondingly labeled utterances. In light of that, ML estimation has a clear disadvantage: it does not take into account the mutual effects between the parameters of different words, thus it cannot take into account confusions between words and recognition errors.

Training methods whose objective function is different from the likelihood function, and that take into account recognition errors, are referred to in the literature as discriminative training methods. Maximum Mutual Information (MMI) is one discriminative training method. The MMI model defines the mutual information between O and W as:

$${I}_{θ} ( O ; W ) = log \frac{{p}_{θ} ( O , W )}{{p}_{θ} ( O ) p ( W )} = log {p}_{θ} ( W \vert O ) - log p ( W ) .$$

Maximizing the above function with respect to θ is equivalent to maximizing the following function:

$$\begin{matrix}M ( θ ) = log {p}_{θ} ( W \vert O ) = {\sum }_{u = 1}^{U} log {p}_{θ} ( {w}^{u} \vert {O}^{u} ) \\ = {\sum }_{u = 1}^{U} log \frac{p ( {w}^{u} ) {p}_{θ} ( {O}^{u} \vert {w}^{u} )}{{\sum }_{v = 1}^{V} p ( v ) {p}_{θ} ( {O}^{u} \vert v )}\end{matrix}$$

The above expression is the MMI objective function. In contrast to the ML objective function, the maximization of M(θ) is performed with respect to the parameters of all the models jointly. The main motivation behind using the M(θ) objective function is to maximize the posterior probabilities of the words given their corresponding utterances, which is the criterion used for recognition.

It was proven by Nádas, in “A decision theoretic formulation of a training problem in speech recognition and a comparison of training by unconditional versus conditional maximum likelihood,” IEEE Trans. on ASSP, 31(4):814-817, 1983, that in the case in which the assumed statistical model is correct, ML estimation yields less variance in the estimation of the parameters than MMI estimation. However, an example in which the assumed statistical model is incorrect, and in which MMI estimation is preferable in the sense that it yields a lower recognition error rate, was given by A. Nádas, D, Nahamoo, and M. A. Picheny in “On a model robust training method for speech recognition,” IEEE Transaction on ASSP, 39(9): 1432-1435, 1988.

Unlike the ML case, there is no simple EM solution to the optimization of the MMI objective function. First experiments in MMI were reported by L. R. Bahl, P. F. Brown, P. V. de Souza and R. L. Mercer in “Maximum mutual information estimation of hidden Markov model parameters for speech recognition”, Proc. ICASSP 86, number 49-52, April 1986. Bahl et al implemented the optimization using a gradient descent algorithm. The gradient descent algorithm, like the EM algorithm, is not guaranteed to converge to the global maximum. In addition, it is sensitive to the size of the update step. A large update step can cause unstable behavior. However a small update step might result in a prohibitively slow convergence rate.

P. S. Gopalakrishnan, D. Kanevsky, A. Nádas, D. Nahamoo, in “An inequality for rational function with applications to some statistical estimation problems” IEEE Transactions on Information Theory, 37(1), January 1991, proposed a method for maximizing the MMI objective function which is based on a generalization of the Baum-Eagon inequality. This method is limited to discrete HMMs. Normandin proposed a heuristic generalization of Gopalakrishnan et al's method to HMMs with Gaussian output densities, in Y. Normandin, R. Cardin, Reneto De Mori “High-performance connected digit recognition using maximum mutual information estimation,” IEEE Transactions on speech and audio processing, 2(2):299-311, 1994. The algorithm Normandin proposed is referred to as the Extended Baum-Welch algorithm.

Many other training methods are known in the art. Corrective training is a discriminative training algorithm introduced by Bahl et al in “A new algorithm for the estimation of hidden Markov model parameters”, in Proc. ICASSP 88, pages 493-496, 1988. Corrective training does not aim to maximize an objective function that has a probabilistic sense, but rather to improve the recognition rate by an iterative correction of recognition errors in the training set.

Another non-probabilistic training method is the Minimum Classification Error (MCE) method. The MCE method was formulated for a general pattern recognition problem by Juang and Katagiri in “Discriminative learning for minimum error training,” IEEE Trans. on ASSP, 40:3043-3054, 1992, and later applied for a speech recognition problem by Juang, Chou and Lee in “Minimum classification error methods for speech recognition,” IEEE Trans. Speech and Audio Processing, 5(3):257-265, 1997.

The basic idea of the MCE method is to regard the pdf's of the HMMs as discriminant functions, and to design the discriminant functions such that the error rate in the training set would be minimized. This is done by choosing a loss function that evaluates the error rate in the training set and is smooth in the parameters, then minimizing the loss function with respect to the parameters.

Other discriminative training methods have been formulated by proposing an objective function and then optimizing it with respect to the parameters. Examples include a method introduced by L. R. Bahl, M. Padmanabhan, D. Nahamoo, P. S. Gopalakrishnan in “Discriminative training of Gaussian mixture models for large vocabulary speech recognition systems,” Proc. ICASSP 96, volume 2, pages 613-16, May 1996. Bahl et al approximated the MMI objective function:

$$M ( θ ) = {\sum }_{u = 1}^{U} \{ log [ p ( {w}^{u} ) {p}_{θ} ( {O}^{u} \vert {w}^{u} ) ] - log {\sum }_{v = 1}^{V} p ( v ) {p}_{θ} ( {O}^{u} \vert v ) \}$$

and optimized it using a process similar to the EM algorithm. The following re-estimation formulas were obtained:

$$\begin{matrix}{\overline{μ}}_{i} = \frac{{\sum }_{t = 1}^{T} {c}_{i}^{mle} ( t ) {o}_{t} - f {\sum }_{t = 1}^{T} {c}_{i}^{d} ( t ) {o}_{t}}{{\sum }_{t = 1}^{T} {c}_{i}^{mle} ( t ) - f {\sum }_{t = 1}^{T} {c}_{i}^{d} ( t )} and : \\ {σ}_{i}^{2} = \frac{ {\sum }_{t = 1}^{T} {c}_{i}^{mle} ( t ) {o}_{t}^{2} - f {\sum }_{t = 1}^{T} {c}_{i}^{d} ( t ) {o}_{t}^{2}}{{\sum }_{t = 1}^{T} {c}_{i}^{mle} ( t ) - f {\sum }_{t = 1}^{T} {c}_{i}^{d} ( t )} - {\overline{μ}}_{i}^{2}\end{matrix}$$

where μᵢ is the mean of the i^{th} state, σᵢ is the variance of the i^{th} state, and f is a prescribed parameter which varies between 0 and 1. cᵢ^{mle}(t) is the posterior probability to occupy state i at time t, given the complete observation sequence O. cᵢ^{d}(t) is the same probability, but calculated according to a model which is a mixture of all states.

Bahl et al chose to approximate the right hand term in the MMI objective function as a stationary HMM that is comprised of a mixture of all the states in all models. Since the approximated term contains neither transition probabilities nor mixture weights, the mixture weight and transition parameters were not re-estimated. Furthermore, each observation was used for the calculation of both the accumulators and the discriminative accumulators. Bahl et al's method was not found to yield an improvement in the recognition rate.

In summary, the objective of the training process is to set the statistical model parameters so as to yield the best performance of the statistical pattern recognition task. The most commonly used method is Maximum Likelihood (ML) estimation. This method is well justified in the theory of parameter estimation and is commonly implemented by the Baum-Welch algorithm. Other prior art discriminative training methods such as Maximum Mutual Information (MMI), corrective training, and Minimum Classification Error (MCE), regard the HMMs as discriminant functions and set their parameters so as to minimize the recognition error rate. These methods outperform ML estimation, but usually are more difficult to implement and often involve a strenuous optimization procedure.

The parameter set resulting from the training process is provided to a statistical pattern recognition system, such as a word spotting speech recognition system. Word spotting differs from continuous speech recognition in that the task involves locating a small vocabulary of keywords (KWs) embedded in an arbitrary conversation rather than determining an optimal word sequence in some fixed vocabulary.

The first word-spotting systems were based on template matching, as described in R. W. Christiansen, C. K. Rushforth, “Detecting and locating key words in continuous speech using linear predictive coding,” IEEE Trans. on ASSP, ASSP-25(5):361-367, October 1977. These systems had a special template for each KW, and these templates were matched to the speech data using Dynamic Time Warping (DTW) techniques.

Reference is now made to FIG. 2, which shows a HMM word-spotter that used below, as introduced by Rose and Paul in “A hidden Markov model based keyword recognition system,” in Proc. ICASSP 90, 2.24, pages 129-132, April 1990. In Rose and Paul's system, each KW was modeled by a HMM and non-KW speech was modeled by several HMMs called fillers. The motivation behind using fillers is to allow the speech recognizer to run continuously on the speech signal, and to mark KWs and non-KW (filler) segments. Fillers are aimed to model all acoustic events that are not KWs including speech, silence, noise etc., and hence they are sometimes referred to as garbage models. Rose and Paul's word-spotter is referred to below as the baseline word-spotter.

The baseline HMM word-spotter works in the following way: the speech signal passes through two continuous speech recognizers in parallel; one recognizer contains KW and filler models and the other recognizer contains only the filler models. Each recognizer outputs the transcription and its corresponding score. The segments that are recognized as KWs by the first recognizer are referred to as putative hits. Each putative hit is given a final score calculated using the two scores given by the recognizers. The final score is then compared to a threshold according to which the putative hits are reported as hits or false alarms.

The score given by the KW+filler recognizer is the average log likelihood per frame, produced by the Viterbi algorithm, namely:

$${S}_{KW} = \frac{log {p}_{θ} ( {o}_{{T}_{i}} , … , {ρ}_{{T}_{f}} , {s}_{{T}_{i}} , … , {s}_{{T}_{f}} \vert v )}{{T}_{f} - {T}_{i}}$$

where v is the KW recognized between the time instances Tᵢ to T_{f}, and s_{Ti}, . . . , s_{Tf} is the optimal state sequence found by the Viterbi algorithm. The score given by the filler only recognizer is:

$${S}_{F} = \frac{log {p}_{θ} ( {o}_{{T}_{i}} , … , {ρ}_{{T}_{f}} , {s}_{{T}_{i}} , … , {s}_{{T}_{f}} \vert f )}{{T}_{f} - {T}_{i}}$$

where s_{Ti}, . . . , s_{Tf} is the optimal state sequence, found by the filler recognizer. Note that these states belong to the sequence of fillers recognized by the Viterbi algorithm. The final score used for decision is:

S_{LR}=S_{KW}−S_{F}

Note that comparing the S_{LR} score to a threshold and varying it, is similar to performing the Likelihood Ratio Test between the filler and KW hypotheses, and varying the hypotheses' prior probabilities. The S_{LR} scoring method is therefore sometimes referred to as Likelihood Ratio Scoring.

Improving the non-KW (filler) modeling, can also help to improve false alarm detection. Rose and Paul examined different types of filler models, including 80 word models, 268 triphone models and 35 monophone models. Monophone models were found most attractive due to their simplicity and relatively good results.

There exist two common ways to model the KWs. The first way is to model each KW by a whole-word HMM and train it over the KW's utterances (word-based models). The second way is to build the KW HMM by concatenating sub-word HMMs according to a pronunciation dictionary (phonetic models). It is clear that a whole-word HMM gives an improved modeling of the KW's acoustics, since it takes into account co-articulation effects, and the duration of every phoneme in the word. However the whole-word HMM might suffer from insufficient training data. Sub-word models can also be preferable when the KW are not known in advance (an “open vocabulary” system), or when they do not appear in the training data at all.

The baseline word-spotting model mentioned above uses ML estimation. In a speech recognition task, discriminative training techniques can enhance the separation between the word models. In a word-spotting task, discriminative training may lead to a better separation between KW and fillers, and thus reduce false alarms and improve the system's performance. R. C. Rose used the corrective training algorithm in “Discriminant word-spotting techniques for rejecting non-vocabulary utterances in unconstrained speech,” Proc. ICASSP 92, volume 2, pages 105-108, March 1992, and showed a significant improvement compared to ML training. However, Rose used a simple tied mixture acoustic model, and the algorithm he proposed could not be generalized to the case of more complex HMMs.

All the parameter estimation techniques discussed above are based upon a statistical model of the system. However, generating a statistical model of a process is often a difficult task, and may be impossible to perform for the most general case. In speech processing systems, for example, the hidden Markov method (HMM) has been found effective as a general model for speech, but it contains a set of parameters whose specific values must be adjusted to the specific conditions in which the system performs. The goal of the training process is to provide these parameter values.

During the training task, the parameter values are determined by inputting a known set of inputs, processing them, and using the results to determine the stastical properties of the inputs. An effective training process is crucial to the performance of many statistical pattern recognition systems. A new training algorithm is needed which outperforms ML, yet is simple to implement.

### SUMMARY OF THE INVENTION

According to a first aspect of the present invention there is thus provided a parameter estimator for estimating a set of parameters for pattern recognition, consisting of: a recognizer for receiving a training set having members and performing recognition on the members using a current set of parameters and a predetermined group of elements, a set generator associated with the recognizer for generating at least one equivalence set comprising recognized ones of the members, a target function determiner associated with the set generator for calculating from at least one of the equivalence sets a target function using the set of parameters, and a maximizer associated with the target function determiner for updating the set of parameters to maximize the target function.

Preferably, the target function comprises a summation, over the elements of the predetermined group of elements, of a difference between a first summation of logarithms of probability density functions as a function of the set of parameters, and a second summation, of logarithms of probability density functions as a function of the set of parameters, multiplied by a discrimination rate, the discrimination rate being variable between zero and one.

Preferably, the target function comprises

$${\sum }_{v = 1}^{V} \{ {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) \}$$

wherein v is an element of the predetermined group of elements, V is the number of elements of the predetermined group of elements, u is the index of a member of the training set, Aᵥ is a set of indices of members of the training set corresponding to element v, Bᵥ is a set of indices of members of the training set corresponding to an equivalence set associated with element v, O^{u} is a u^{th} member of the training set, λ is the discrimination rate, θ is the set of parameters, and p_{θ}(.|v) is a predetermined probability density function of element v using the set of parameters.

Preferably, the parameter estimator further comprises an initial estimator associated with the recognizer for calculating an initial estimate of the parameter set.

Preferably, the initial estimate comprises a maximum likelihood estimate.

Preferably, the parameter estimator further comprises a discrimination rate tuner associated with the target function determiner for tuning the discrimination rate within the range.

Preferably, the discrimination rate tuner is operable to tune the discrimination rate to a constant value for all members of the training set.

Preferably, for a given member of the training set, the discrimination rate tuner is operable to tune the discrimination rate to a respective discrimination rate level associated with the member.

Preferably, the discrimination rate is tunable so as to optimize the parameter set according to a predetermined optimization criterion.

Preferably, the maximizer is further operable to feed back the updated parameter set to the recognizer.

Preferably, the parameter estimator comprises an iterative device.

Preferably, the parameter estimator further comprises a parameter outputter associated with the maximizer and a statistical pattern recognition system for outputting at least some of the updated parameter set.

Preferably, the statistical pattern recognition system comprises a speech recognition system.

Preferably, the speech recognition system comprises a word-spotting system.

Preferably, the statistical pattern recognition system includes one of a group comprising: image recognition, decryption, communications, sensory recognition, optical, optical character recognition (OCR), natural language processing (NLP), gesture and object recognition (for machine vision), text classification, and control systems.

Preferably, the maximizer comprises an iterative device comprising: an auxiliary function determiner for forming an auxiliary function associated with the target function from a current estimate of the set of parameters, and an auxiliary function maximizer for updating the set of parameters to maximize the auxiliary function.

Preferably, the auxiliary function comprises a summation, over the elements of the predetermined group of elements, of a difference between a first summation of conditional expected value functions as a function of the set of parameters, and a second summation, of conditional expected value functions as a function of the set of parameters, multiplied by a discrimination rate, the discrimination rate being variable between zero and one.

Preferably, the auxiliary function comprises

$${\sum }_{v = 1}^{V} \{ {\sum }_{u ∈ {A}_{v}} {E}_{{θ}^{( l )}} \{ log f χ ( {x}^{u} ; θ ) \vert {y}^{u} \} - λ {\sum }_{u ∈ {B}_{v}} {E}_{{θ}^{( l )}} \{ log f χ ( {x}^{u} ; θ ) \vert {y}^{u} \} \}$$

wherein l is a step number, θ^{(l)} is an estimate of the set of parameters at step l, y^{u} is a u^{th} member of the training set, x^{u} is a u^{th} member of a second data set associated with the training set, f_{X}(x^{u};θ) is a predetermined probability density function of data member x^{u} of the second data set using the set of parameters, and E_{θ}_{^{(l)}}{.|y^{u}} is a conditional expected value function conditional upon member y^{u} of the training set using the estimate of the set of parameters at step l.

Preferably, the second data set comprises a complete data set.

Preferably, the parameter estimator further comprises an initial estimator associated with the maximizer for calculating an initial estimate of the parameter set.

Preferably, the initial estimate comprises a maximum likelihood estimate.

Preferably, the statistical pattern recognition system comprises a speech recognition system, the members of the training set comprise utterances, and the predetermined group of elements comprises a predetermined vocabulary of words.

Preferably, the recognizer comprises a Viterbi recognizer.

Preferably, the parameters comprise parameters of a statistical model.

Preferably, the statistical model comprises a hidden Markov model (HMM).

According to a second aspect of the present invention there is thus provided a parameter estimator for estimating a set of parameters for word-spotting pattern recognition, which consists of: a recognizer for receiving a training set, performing recognition on the training set using a current set of parameters and a predetermined group of elements, and providing recognized transcriptions of the training set, a target function determiner associated with the recognizer for calculating from at least one of the recognized transcriptions a target function using the set of parameters, and a maximizer associated with the target function determiner for updating the set of parameters to maximize the target function.

Preferably, the target function comprises a difference between: a logarithm of a first probability density function as a function of the set of parameters, and a logarithm of a second probability density function as a function of the set of parameters, multiplied by a discrimination rate, the discrimination rate being variable between zero and one.

Preferably, the target function comprises

log p_{θ}(O|W)−λ log p_{θ}(O|Ŵ)

wherein W is a possible transcription of the training set, Ŵ is a recognized transcription of the training set, O is the training set, λ is the discrimination rate, θ is the set of parameters, and p_{θ}(.|.) is a predetermined probability density function using the set of parameters.

Preferably, the parameter estimator further comprises an initial estimator associated with the recognizer for calculating an initial estimate of the parameter set.

Preferably, the initial estimate comprises a maximum likelihood estimate.

Preferably, the parameter estimator further comprises a discrimination rate tuner associated with the target function determiner for tuning the discrimination rate within the range.

Preferably, the discrimination rate is tunable so as to optimize the parameter set according to a predetermined optimization criterion.

Preferably, the maximizer is further operable to feed back the updated parameter set to the recognizer.

Preferably, the parameter estimator comprises an iterative device.

Preferably, the parameter estimator further comprises a parameter outputter associated with the maximizer and a word-spotting pattern recognition system for outputting at least some of the updated parameter set.

Preferably, the maximizer comprises an iterative device consisting of an auxiliary function determiner for forming an auxiliary function associated with the target function from a current estimate of the set of parameters, and an auxiliary function maximizer for updating the set of parameters to maximize the auxiliary function.

According to a third aspect of the present invention there is thus provided a pattern recognizer for performing statistical pattern recognition upon an input sequence, the pattern recognizer being operable to transcribe the input sequence into an output sequence, the output sequence comprising elements from a predetermined group of elements, the pattern recognizer consists of a transcriber for performing the transcription according to a predetermined statistical model having a set of parameters, and a parameter estimator for providing the set of parameters. The parameter estimator consists of a recognizer for receiving a training set having members and performing recognition on the members using a current set of parameters and the predetermined group of elements, a set generator associated with the recognizer for generating at least one equivalence set comprising recognized ones of the members, a target function determiner associated with the set generator for calculating from at least one of the equivalence sets a target function using the set of parameters, and a maximizer associated with the target function determiner for updating the set of parameters to maximize the target function.

Preferably, the target function comprises a summation, over the elements of the predetermined group of elements, of a difference between a first summation of logarithms of probability density functions as a function of the set of parameters, and a second summation, of logarithms of probability density functions as a function of the set of parameters, multiplied by a discrimination rate, the discrimination rate being variable between zero and one.

Preferably, the target function comprises

$${\sum }_{v = 1}^{V} \{ {\sum }_{u ∈ {A}_{v}} log {p}_{θ} ( {O}^{u} \vert v ) - {\sum }_{u ∈ {B}_{v}} log {p}_{θ} ( {O}^{u} \vert v ) \}$$

wherein v is an element of the predetermined group of elements, V is the number of elements of the predetermined group of elements, u is the index of a member of the training set, Aᵥ is a set of indices of members of the training set corresponding to element v, Bᵥ is a set of indices of members of the training set corresponding to an equivalence set associated with element v, O^{u} is a u^{th} member of the training set, λ is the discrimination rate, θ is the set of parameters, and p_{θ}(.|v) is a predetermined probability density function of element v using the set of parameters.

Preferably, the pattern recognizer further comprises an initial estimator associated with the recognizer for calculating an initial estimate of the parameter set.

Preferably, the maximizer is further operable to feed back the updated parameter set to the recognizer.

Preferably, the parameter estimator comprises an iterative device.

Preferably, the maximizer comprises an iterative device comprising: an auxiliary function determiner for forming an auxiliary function associated with the target function from a current estimate of the set of parameters, and an auxiliary function maximizer for updating the set of parameters to maximize the auxiliary function.

Preferably, the auxiliary function comprises a summation, over the elements of the predetermined group of elements, of a difference between a first summation of conditional expected value functions as a function of the set of parameters, and a second summation, of conditional expected value functions as a function of the set of parameters, multiplied by a discrimination rate, the discrimination rate being variable between zero and one.

Preferably, the auxiliary function comprises

$${\sum }_{v = 1}^{V} \{ {\sum }_{u ∈ {A}_{v}} {E}_{{θ}^{( l )}} \{ log f χ ( {x}^{u} ; θ ) \vert {y}^{u} \} - λ {\sum }_{u ∈ {B}_{v}} {E}_{{θ}^{( l )}} \{ log f χ ( {x}^{u} ; θ ) \vert {y}^{u} \} \}$$

wherein l is a step number, θ^{(l)} is an estimate of the set of parameters at step l, y^{u} is a u^{th} member of the training set, x^{u} is a u^{th} member of a second data set associated with the training set, f_{X}(x^{u};θ) is a predetermined probability density function of data member x^{u} of the second data set using the set of parameters, and E_{θ}_{^{(l)}}{.|y^{u}} is a conditional expected value function conditional upon member y^{u} of the training set using the estimate of the set of parameters at step l.

Preferably, the statistical pattern recognition comprises speech recognition.

Preferably, the members of the training set comprise utterances and the predetermined group of elements comprises a predetermined vocabulary of words.

Preferably, the recognizer comprises a Viterbi recognizer.

Preferably, the statistical pattern recognition system includes one of a group comprising: image recognition, decryption, communications, sensory recognition, optical character recognition (OCR), natural language processing (NLP), gesture and object recognition (for machine vision), text classification, and control systems.

Preferably, the statistical model comprises a hidden Markov model (HMM).

Preferably, the input sequence comprises a continuous sequence.

Preferably, the output sequence comprises a continuous sequence.

According to a fourth aspect of the present invention there is thus provided a speech recognizer for performing statistical speech processing upon an input sequence of utterances, the speech recognizer being operable to transcribe the input sequence into an output sequence, the output sequence comprising words from a predetermined vocabulary, the speech recognizer comprising: a transcriber for performing the transcription according to a predetermined statistical model having a set of parameters, and a parameter estimator for providing the set of parameters. The parameter estimator consists of a recognizer for receiving a training set having utterances and performing recognition on the utterances using a current set of parameters and the predetermined vocabulary, a set generator associated with the recognizer for generating at least one equivalence set comprising recognized ones of the utterances, a target function determiner associated with the set generator for calculating from at least one of the equivalence sets a target function using the set of parameters, and a maximizer associated with the target function determiner for updating the set of parameters to maximize the target function.

Preferably, the statistical model comprises a hidden Markov model (HMM).

Preferably, the target function comprises a summation, over the elements of the predetermined group of elements, of a difference between a first summation of logarithms of probability density functions as a function of the set of parameters, and a second summation, of logarithms of probability density functions as a function of the set of parameters, multiplied by a discrimination rate, the discrimination rate being variable between zero and one.

Preferably, the target function comprises

$${\sum }_{v = 1}^{V} \{ {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) \}$$

wherein v is a word of the predetermined vocabulary, V is the number of elements of the predetermined group of elements, u is the index of an utterance of the training set, Aᵥ is a set of indices of utterances of the training set corresponding to word v, Bᵥ is a set of indices of utterances of the training set corresponding to an equivalence set associated with word v, O^{u} is a u^{th} utterance of the training set, λ is the discrimination rate, θ is the set of parameters, and p_{θ}(.|v) is a predetermined probability density function of word v using the set of parameters.

Preferably, the speech recognizer further comprises an initial estimator associated with the recognizer for calculating an initial estimate of the parameter set.

Preferably, the maximizer is further operable to feed back the updated parameter set to the recognizer.

Preferably, the parameter estimator comprises an iterative device.

Preferably, the maximizer comprises an iterative device comprising: an auxiliary function determiner for forming an auxiliary function associated with the target function from a current estimate of the set of parameters, and an auxiliary function maximizer for updating the set of parameters to maximize the auxiliary function.

Preferably, the auxiliary function comprises a summation, over the elements of the predetermined group of elements, of a difference between a first summation of conditional expected value functions as a function of the set of parameters, and a second summation, of conditional expected value functions as a function of the set of parameters, multiplied by a discrimination rate, the discrimination rate being variable between zero and one.

Preferably, the auxiliary function comprises

$${\sum }_{v = 1}^{V} \{ {\sum }_{u ∈ {A}_{v}} {E}_{{θ}^{( l )}} \{ log fχ ( {x}^{u} ; θ ) \vert {y}^{u} \} - λ {\sum }_{u ∈ {B}_{v}} {E}_{{θ}^{( l )}} \{ log fχ ( {x}^{u} ; θ ) \vert {y}^{u} \} \}$$

wherein l is a step number, θ^{(l)} is an estimate of the set of parameters at step l, y^{u} is a u^{th} utterance of the training set, x^{u} is a u^{th} utterance of a second data set associated with the training set, f_{X}(x^{u};θ) is a predetermined probability density function of data utterance x^{u} of the second data set using the set of parameters, and E_{θ}_{^{(l)}}{.|y^{u}} is a conditional expected value function conditional upon utterance y^{u} of the training set using the estimate of the set of parameters at step l.

Preferably, the recognizer comprises a Viterbi recognizer.

Preferably, the speech recognizer further comprises a converter for converting the input sequence of utterances into a sequence of samples representing a speech waveform.

Preferably, the speech recognizer further comprises a feature extractor for extracting from the sequence of samples a feature vector for processing by the transcriber, and wherein a dimension of the feature vector is less than a dimension of the sequence of samples.

Preferably, the speech recognizer further comprises a language modeler, for providing grammatical constraints to the transcriber.

Preferably, the speech recognizer further comprises an acoustic modeler for embedding acoustic constraints into the statistical model.

Preferably, the input sequence comprises a continuous speech sequence.

Preferably, the output sequence comprises a continuous speech sequence.

Preferably, the utterances comprise keywords and non-keywords, and wherein the speech recognizer is further operable to identify the keywords within the input sequence.

According to a fifth aspect of the present invention there is thus provided a parameter estimator for estimating a set of parameters for pattern recognition, comprising a recognizer for receiving a training set having members and performing recognition on the members using a current set of parameters and a predetermined group of elements, a set generator associated with the recognizer for generating at least one equivalence set comprising recognized ones of the members, a numerator calculator, associated with the set generator, operable to calculate, for a given parameter and a set of indices of training set members, a respective numerator accumulator, a denominator calculator associated with the set generator, operable to calculate, for the given parameter and a set of indices of training set members, a respective denominator accumulator, and an evaluator, associated with the numerator calculator and the denominator calculator. The evaluator calculates a quotient, for the given parameter. The quotient is calculated between a first and a second difference. The first difference is the difference between a first numerator accumulator, calculated for the given parameter and a set of indices of training set members corresponding to a given element v, and a second numerator accumulator, calculated for the given parameter and a set of indices of training set members corresponding to an equivalence set associated with element v, multiplied by a discrimination rate. The second difference is the difference between a first denominator accumulator, calculated for the given parameter and the set of indices of training set members corresponding to element v, and a second denominator accumulator, calculated for the given parameter and the set of indices of training set members corresponding to the equivalence set associated with element v, multiplied by a discrimination rate which varies between zero and one.

Preferably, the parameters comprise parameters of a statistical model.

Preferably, the statistical model comprises a hidden Markov model (HMM).

Preferably, the statistical model includes one of a group comprising: Gaussian distribution, and Gaussian mixture distribution.

Preferably, the numerator calculator is operable to calculate the numerator accumulator for the given parameter in accordance with a maximum likelihood estimate of a numerator accumulator of the parameter.

Preferably, the quotient is

$$\frac{N ( b ) - λ {N}_{D} ( b )}{D ( b ) - λ {D}_{D} ( b )}$$

where b is the given parameter, N(b) is the first numerator, N_{D}(b) is the second numerator, λ is the discrimination rate, D(b) is the first denominator, and D_{D}(b) is the second denominator.

Preferably, the denominator calculator is operable to calculate the denominator accumulator for the given parameter in accordance with a maximum likelihood estimate of a denominator accumulator of the parameter.

According to a sixth aspect of the present invention there is thus provided a method for estimating a set of parameters for insertion into a statistical pattern recognition process. The method is performed by determining initial values for the set of parameters; and performing estimation cycles. An estimation cycle is performed by: receiving a training set having members, performing recognition on the members using a current set of parameters and a predetermined group of elements, generating at least one equivalence set comprising recognized members of the training set, using the equivalence sets and the set of parameters to calculate a target function, maximizing the target function with respect to the set of parameters, then updating the set of parameters to maximize the target function. If the set of parameters satisfies a predetermined estimation termination condition, the parameters are output and the parameter estimation method is discontinued. Otherwise another estimation cycle is performed.

Preferably, the target function comprises a summation, over the elements of the predetermined group of elements, of a difference between a first summation of logarithms of probability density functions as a function of the set of parameters, and a second summation, of logarithms of probability density functions as a function of the set of parameters, multiplied by a discrimination rate, the discrimination rate being variable between zero and one.

Preferably, the target function comprises

$${\sum }_{v = 1}^{V} \{ {\sum }_{u ∈ {A}_{v}} log {p}_{0} ( {O}^{u} \vert v ) - λ {\sum }_{u ∈ {B}_{v}} log {p}_{0} ( {O}^{u} \vert v ) \}$$

wherein v is an element of the predetermined group of elements, V is the number of elements of the predetermined group of elements, u is the index of a member of the training set, Aᵥ is a set of indices of members of the training set corresponding to element v, Bᵥ is a set of indices of members of the training set corresponding to an equivalence set associated with element v, O^{u} is a u^{th} member of the training set, λ is the discrimination rate, θ is the set of parameters, and p_{θ}(.|v) is a predetermined probability density function of element v using the set of parameters.

Preferably, the method comprises the further step of tuning the discrimination rate.

Preferably, the method comprises the further step of providing at least some of the updated parameter set to a statistical pattern recognition process.

Preferably, the statistical pattern recognition process comprises a speech recognition process.

Preferably, the statistical pattern recognition process includes one of a group comprising: image recognition, decryption, communications, sensory recognition, optical, optical character recognition (OCR), natural language processing (NLP), gesture and object recognition (for machine vision), text classification, and control processes.

Preferably, the step of maximizing the target function with respect to the set of parameters comprises performing maximization cycles. A maximization cycle consists of the following steps: using a current estimate of the set of parameters to calculate an auxiliary function associated with the target function, maximizing the auxiliary function with respect to the set of parameters, updating the set of parameters to maximize the target function. Finally, if the set of parameters satisfies a predetermined maximization termination condition, the parameters are output and the parameter maximization is discontinued. Otherwise, another maximization cycle is discontinued.

Preferably, the auxiliary function comprises a summation, over the elements of the predetermined group of elements, of a difference between a first summation of conditional expected value functions as a function of the set of parameters, and a second summation, of conditional expected value functions as a function of the set of parameters, multiplied by a discrimination rate, the discrimination rate being variable between zero and one.

Preferably, the auxiliary function comprises

$${\sum }_{v = 1}^{V} \{ {\sum }_{u ∈ {A}_{v}} {E}_{{θ}^{( l )}} \{ log fχ ( {x}^{u} ; θ ) \vert {y}^{u} \} - λ {\sum }_{u ∈ {B}_{v}} {E}_{{θ}^{( l )}} \{ log fχ ( {x}^{u} ; θ ) \vert {y}^{u} \} \}$$

wherein l is a step number, θ^{(l)} is an estimate of the set of parameters at step l, y^{u} is a u^{th} member of the training set, x^{u} is a u^{th} member of a second data set associated with the training set, f_{X}(x^{u};θ) is a predetermined probability density function of data member x^{u} of the second data set using the set of parameters, and E_{θ}_{^{(l)}}{.|y^{u}} is a conditional expected value function conditional upon member y^{u} of the training set using the estimate of the set of parameters at step l.

Preferably, the second data set comprises a complete data set.

Preferably, the statistical pattern recognition process comprises a speech recognition process, the members of the training set comprise utterances, and the predetermined group of elements comprises a predetermined vocabulary of words.

Preferably, the performing recognition on the members comprises performing Viterbi recognition on the members.

Preferably, determining initial values for the set of parameters comprises performing maximum likelihood estimation to determine the initial values.

Preferably, the statistical process uses a hidden Markov model (HMM).

According to a seventh aspect of the present invention there is thus provided a method for performing statistical pattern recognition upon an input sequence, thereby to transcribe the input sequence into an output sequence comprising elements from a predetermined group of elements. The method comprises the steps of: receiving the input sequence and estimating a set of parameters of a statistical model. The parameters are estimated by: determining initial values for the set of parameters, and performing an estimation cycle. The estimation cycle comprises the steps of: receiving a training set having members, performing recognition on the members using a current set of parameters and the predetermined group of elements, generating at least one equivalence set comprising recognized members of the training set, using the equivalence sets and the set of parameters to calculate a target function, maximizing the target function with respect to the set of parameters, and updating the set of parameters to maximize the target function. Then, if the set of parameters satisfies a predetermined estimation termination condition, discontinuing the parameter estimation; otherwise another estimation cycle is performed. After the estimation is completed, the input sequence is transcribed according to the statistical model having the estimated set of parameters.

Preferably, the target function comprises a summation, over the elements of the predetermined group of elements, of a difference between a first summation of logarithms of probability density functions as a function of the set of parameters, and a second summation, of logarithms of probability density functions as a function of the set of parameters, multiplied by a discrimination rate, the discrimination rate being variable between zero and one.

Preferably, the target function comprises

$${\sum }_{v = 1}^{V} \{ {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) \}$$

wherein v is an element of the predetermined group of elements, V is the number of elements of the predetermined group of elements, u is the index of a member of the training set, Aᵥ is a set of indices of members of the training set corresponding to element v, Bᵥ is a set of indices of members of the training set corresponding to an equivalence set associated with element v, O^{u} is a u^{th} member of the training set, λ is the discrimination rate, θ is the set of parameters, and p_{θ}(.|v) is a predetermined probability density function of element v using the set of parameters.

Preferably, the method comprises the further step of tuning the discrimination rate.

Preferably, the statistical pattern recognition process comprises a speech recognition process.

Preferably, the statistical pattern recognition process comprises one of the following types of processes: image recognition, decryption, communications, sensory recognition, optical, optical character recognition (OCR), natural language processing (NLP), gesture and object recognition (for machine vision), text classification, and control.

Preferably, the step of maximizing the target function with respect to the set of parameters comprises performing maximization cycles. The maximization cycle comprises the steps of: using a current estimate the set of parameters to calculate an auxiliary function associated with the target function, maximizing the auxiliary function with respect to the set of parameters, updating the set of parameters to maximize the target function. Finally, if the set of parameters satisfies a predetermined maximization termination condition, the parameters are output and the parameter maximization is discontinued. Otherwise, another maximization cycle is performed.

Preferably, the auxiliary function comprises a summation, over the elements of the predetermined group of elements, of a difference between a first summation of conditional expected value functions as a function of the set of parameters, and a second summation, of conditional expected value functions as a function of the set of parameters, multiplied by a discrimination rate, the discrimination rate being variable between zero and one.

Preferably, the auxiliary function comprises

$${\sum }_{v = 1}^{V} \{ {\sum }_{u ∈ {A}_{v}} {E}_{{θ}^{( l )}} \{ log fχ ( {x}^{u} ; θ ) \vert {y}^{u} \} - λ {\sum }_{u ∈ {B}_{v}} {E}_{{θ}^{( l )}} \{ log fχ ( {x}^{u} ; θ ) \vert {y}^{u} \} \}$$

wherein l is a step number, θ^{(l)} is an estimate of the set of parameters at step l, y^{u} is a u^{th} member of the training set, x^{u} is a u^{th} member of a second data set associated with the training set, f_{X}(x^{u};θ) is a predetermined probability density function of data member x^{u} of the second data set using the set of parameters, and E_{θ}_{^{(l)}}{.|y^{u}} is a conditional expected value function conditional upon member y^{u} of the training set using the estimate of the set of parameters at step l.

Preferably, the statistical pattern recognition comprises speech recognition, the members of the training set comprise utterances, and the predetermined group of elements comprises a predetermined vocabulary of words.

Preferably, performing recognition on the members comprises performing Viterbi recognition on the members.

Preferably, transcribing the input sequence comprises performing Viterbi recognition upon the input sequence.

Preferably, determining initial values for the set of parameters comprises performing maximum likelihood estimation to determine the initial values.

Preferably, the statistical model comprises a hidden Markov model (HMM).

Preferably, the input sequence comprises a continuous sequence.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows the structure of a typical hidden Markov model (HMM) speech recognizer.

FIG. 2 shows a known HMM word-spotter

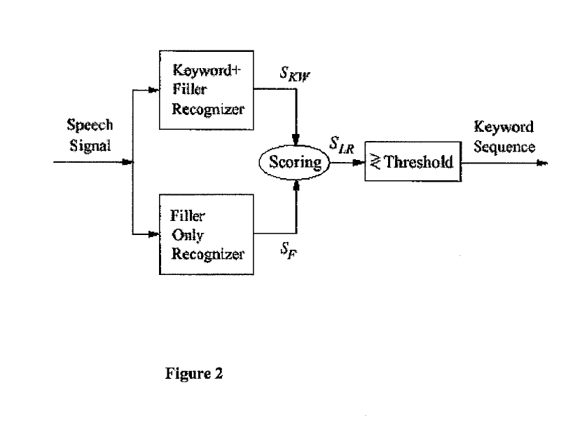

FIG. 3 is a simplified block diagram of a parameter estimator according to a preferred embodiment of the present invention.

FIGS. 4a and 4b show the behavior of the threshold Pₑᵣᵣₒᵣ and T_{MMI} respectively, as a function of the parameter λ.

FIG. 5 is a simplified block diagram of a maximizer, according to a preferred embodiment of the present invention.

FIG. 6 is a simplified block diagram of a parameter estimator, according to a preferred embodiment of the present invention.

FIG. 7 is a simplified block diagram of a parameter estimator, according to a preferred embodiment of the present invention.

FIG. 8 is a simplified block diagram of a pattern recognizer, according to a preferred embodiment of the present invention.

FIG. 9 is a simplified flow chart of a method for estimating a set of parameters for insertion into a statistical pattern recognition process, according to a preferred embodiment of the present invention.

FIG. 10 is a simplified flow chart of a method for maximizing the target function with respect to the set of parameters, according to a preferred embodiment of the present invention.

FIG. 11 is a simplified flow chart of a method for performing statistical pattern recognition upon an input sequence, according to a preferred embodiment of the present invention.

FIGS. 12a and 12b show the recognition rate on the training set after one iteration of the algorithm as a function of λ and the corresponding recognition rate on the test set respectively.

FIG. 13 shows the evolution of several criteria along successive Approximation, Maximization iterations.

FIG. 14 shows the corresponding evolution of the criteria of FIG. 13 along Maximization iterations.

FIG. 15 shows experimental results of the improvement in the receiver operating characteristics (ROC) for two word-spotting experiments.

### DESCRIPTION OF THE PREFERRED EMBODIMENTS

Pattern recognition systems are found in a wide range of technologies, such as speech processing, image recognition, digital communication, and decryption. Statistical pattern recognition is a pattern recognition method which relies on known, or assumed, statistical properties of the process. The precision of these systems depends on the precision to which the statistical model reflects the statistical properties of the process itself. The more closely and accurately the process can be modeled, the more accurately the pattern recognition systems can perform. The training process is a vital element of the process modeling. Even a recognition system with a very effective model may yield poor performance if the parameter values within the model are incorrect.

As discussed above, the ML objective function enables a simple, useful, and theoretically justifiable training process, but which might not work well when the assumed statistical model is incorrect or when the training data is sparse. On the other hand, the MMI objective function can overcome these shortcomings in many systems and compensate for inaccuracy in the statistical model, but leads to a complex training process. An objective function can be derived from the ML and MMI training methods, which combines the advantages of simple training and improved recognition system performance.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

In order to combine the advantages of MMI and ML training, a target function is sought which is similar to the MMI objective function discussed above, but which can be maximized for each statistical model representing a class separately as with ML, and not for all of them jointly as with MMI. As shown above, the MMI objective function is:

$$\begin{matrix}M ( θ ) = log {p}_{θ} ( W \vert O ) \\ = {\sum }_{u = 1}^{U} log {p}_{θ} ( {w}^{u} \vert {O}^{u} ) \\ = {\sum }_{u = 1}^{U} log \frac{p ( {w}^{u} ) {p}_{θ} ( {O}^{u} \vert {w}^{u} )}{{\sum }_{v = 1}^{V} p ( v ) {p}_{θ} ( {O}^{u} \vert v )} \\ thus : \\ M ( θ ) = {\sum }_{u = 1}^{U} \{ log [ p ( {w}^{u} ) {p}_{θ} ( {O}^{u} \vert {w}^{u} ) ] - log {\sum }_{v = 1}^{V} p ( v ) {p}_{θ} ( {O}^{u} \vert v ) \}\end{matrix}$$

Applying the approximation:

$$log {\sum }_{i} {X}_{i} \approx log \{ max {X}_{i} \}$$

on the right hand sum of M(θ) yields:

$$M ( θ ) \approx {\sum }_{u = 1}^{U} \{ log \vert p ( {w}^{u} ) {p}_{θ} ( {O}^{u} \vert {w}^{u} ) ] - log {max}_{v} [ p ( v ) {p}_{θ} ( {O}^{u} \vert v ) ] \}$$

Note that M(θ) can now be maximized for each training set utterance independently. As shown above, the Aᵥ sets are defined as: Aᵥ={u|w^{u}=v}. Define the Bᵥ sets as:

$${B}_{υ} {△}_{=} \{ u \vert v = arg {max}_{w} ( p ( w ) {p}_{θ} ( {O}^{u} \vert w ) ) \} .$$

The Bᵥ sets will be referred to below as equivalence sets. Using the MAP criterion for recognition, the Bᵥ sets contain the indices of training utterances that were recognized as the word v. Using these two definitions rewrite:

$$M ( θ ) \approx {\sum }_{v = 1}^{V} \{ {\sum }_{u ∈ {A}_{v}} log [ p ( v ) {p}_{θ} ( {O}^{u} \vert v ) ] - {\sum }_{u ∈ {B}_{v}} log [ p ( v ) {p}_{θ} ( {O}^{u} \vert v ) ] \} .$$

A new objective function is defined as follows, and is called the approximated MMI criterion:

$${J}_{λ} ( θ ) = {\sum }_{v = 1}^{V} \{ {\sum }_{u ∈ {A}_{v}} log [ p ( v ) {p}_{υ} ( {O}^{u} \vert v ) ] - λ {\sum }_{u ∈ {B}_{v}} log [ p ( v ) {p}_{θ} ( {O}^{u} \vert v ) ] \}$$

where the discrimination rate, λ, is a prescribed parameter in the range of zero and one. The approximated MMI criterion is similar in form to the MMI objective function. Note that with λ=0 the approximated MMI criterion is equivalent to the ML objective function, and with λ=1 the approximated MMI criterion is equivalent to the MMI objective function under the above approximation of M(θ). In the derivation of the maximization formulas below a small value of λ is assumed.

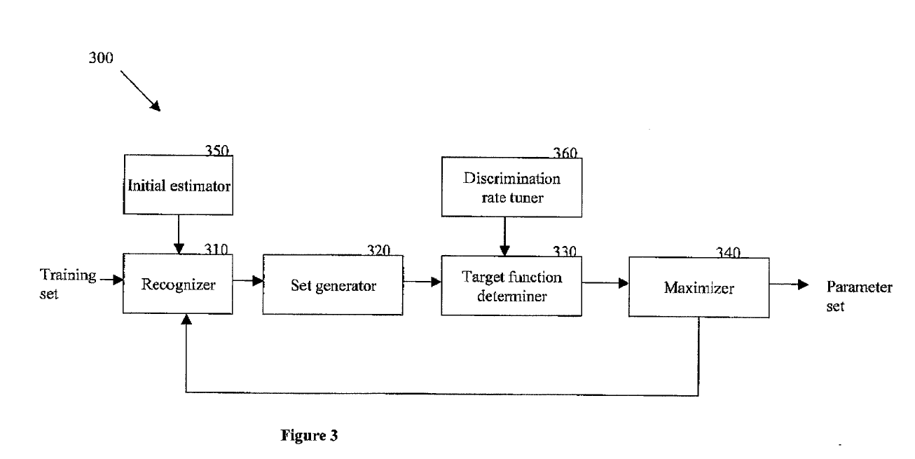

A trainer can be based on the approximated MMI function. Reference is now made to FIG. 3, which is a simplified block diagram of a preferred embodiment of a parameter estimator 300 for estimating a set of parameters for pattern recognition. Parameter estimator 300 consists of a recognizer 310, a set generator 320, a target function determiner 330, and a maximizer 340.

The parameter trainer can be used for any parameter estimation problem which consists of more than one class. The training set members are input into recognizer 310. Recognizer 310 performs recognition on the members, and provides an output transcription of the input. The recognition performed during training mimics the recognition performed by the pattern recognizer. Thus the recognizer inputs and outputs are similar in type to the parameter estimator inputs and outputs. Both the training set members and the transcription elements are determined by the type of system being modeled. The transcription elements consist of a limited number of predetermined elements. For example, in the speech recognition system discussed above, the training set members are utterances, and the transcription elements are words taken from a predetermined vocabulary.

Recognition may be performed by any recognition method known in the art. In the preferred embodiment, recognizer 350 comprises a Viterbi recognizer. Other recognition methods may be used. For example, in a speech recognition system when the training set consists of continuous utterances of words, recognition can be performed in several ways: using the boundaries of the words in the transcription, not using the word boundaries but using Viterbi recognition with a language model, various choices of language models, etc.

Set generator 320 processes the recognized output from the recognizer, and generates at least one equivalence set. An equivalence set is a set of training set members which have been recognized by the recognizer as the same element (i.e. a Bᵥ set as defined above). The target function determiner 330 then uses one or more equivalence set to calculate a target function. The target function is the parameter estimation objective function for a single transcription element (for example a selected word). The target function is calculated for each element using the current estimated value of the set of parameters, the original training set and its indices, and the discrimination rate, λ. In the preferred embodiment, the initial values of the parameter set are calculated by an initial estimator 350. The initial estimator 350 calculates an initial estimate of the parameter set. The initial estimate is used by the recognizer 310 during the recognition process. The initial estimate of the parameter set may also be used by the maximizer, during maximization of the target function. In the preferred embodiment the initial estimate is a maximum likelihood estimate.

Maximizer 340 updates the parameter set to values which maximize the target function. A preferred embodiment of the maximizer 340, based on the EM algorithm, is described later.

In the preferred embodiment, the target function is based on the approximated MMI criterion. For the approximated MMI criterion, the prior probabilities of the words, p(v), affect the performance of the recognizer 310, but do not affect the maximization of J_{λ}(θ). The approximated MMI target function is:

$${J}_{λ} ( θ ) = {\sum }_{v = 1}^{V} \{ {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) \}$$

v is an element of the predetermined group of elements that make up the transcription, V is the number of elements of the predetermined group of elements, and u is the index of a training set member. Aᵥ and Bᵥ are sets of indices of training set members. For a given element v, Aᵥ is a set of indices of the appearances of v in the training set, and Bᵥ is a set of indices of appearances of v in the transcription. In other words, Bᵥ is a set of indices of members of an equivalence set of v. The discrimination rate, λ, varies between 0 and 1.

Maximizing the approximated MMI target function can be performed for each element v separately. The approximated MMI target function, for a given element v, is:

$${J}_{λ}^{v} ( θ ) = {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) .$$

In a more general preferred embodiment, the target function is a summation, over the elements of the predetermined group of elements, of a difference between a first summation of logarithms of probability density functions as a function of the set of parameters, and a second summation, of logarithms of probability density functions as a function of the set of parameters, multiplied by a discrimination rate, λ. The discrimination rate is variable between zero and one, as above.

The discrimination rate, λ, is a target function parameter which may be set to any suitable value between 0 and 1. Generally, a small value of λ provides better maximizer performance, but less discrimination. In the preferred embodiment, the parameter estimator 300 includes a discrimination rate tuner 360. The discrimination rate tuner 360 tunes the discrimination rate of the target function within the allowed range. In one preferred embodiment the discrimination rate is set to a constant value for all members of the training set. In an alternate preferred embodiment, the discrimination rate may be tuned to a different discrimination rate level for each training set member. The discrimination rate may be tuned so as to optimize the parameter set according to a predetermined optimization criterion, such as minimizing the recognition error rate on the training set.

In the preferred embodiment the updated parameter set at the maximizer 340 output is fed back to the recognizer 310. Parameter estimator 300 may thus comprise an iterative device. The order of the steps in the iterations may vary. As will be described below, the maximizer may also comprise an iterative device, thus the iteration cycles may comprise various combinations such as: applying recognition, maximization, and recognition successively, or applying recognition and then several iterations of maximization.

In the preferred embodiment, the parameter estimator 300 also includes a parameter outputter associated with the maximizer and a statistical pattern recognition system. The parameter outputter outputs some or all of the updated parameter set to the statistical pattern recognition system. The parameters may then be used by the pattern recognition system for performing pattern recognition. The statistical pattern recognition system may comprise a speech recognition system, for example a word-spotting system. In a word based speech recognition system, the members of the training set comprise utterances, and the predetermined group of elements is a predetermined vocabulary of words. Other types of statistical pattern recognition systems include: image recognition, decryption, communications, sensory recognition, optical, optical character recognition (OCR), natural language processing (NLP), gesture and object recognition (for machine vision), text classification, and control systems.

In a preferred embodiment, the statistical model is a hidden Markov model (HMM). The HMM has been found to be an effective model for speech recognition systems. The application of the embodiment to the HMM model is discussed below.

Following is an of example parameter estimation in pattern recognition in which the approximated MMI criterion provides a better decision rule than the ML criterion, in the sense that it yields a smaller probability of error. The example is a classification problem with two classes, namely, a given observation x is to be assigned to one of two classes w₁ or w₂. The prior probabilities of the classes are equal, i.e.

$$p ( {w}_{1} ) = p ( {w}_{2} ) = \frac{1}{2} .$$

The conditional density function of the first class, p(x|w₁), is a Gaussian density function with mean −μ and variance σ₁². The conditional density function of the second class, p(x|w₂), is a Gaussian density function with mean μ and variance σ₂². In the given case, since the prior probabilities of the classes are equal, the decision rule derived from the MAP criterion is:

p(x|w₁)_{<w}_{₂}^{>w}^{₁}p(x|w₂)

The MAP solution is the optimal solution to the given problem, in the sense that it reaches the minimal probability of error in classification. Decision regions can be obtained by an explicit solution of the MAP solution. When σ₂²>σ₁² the decision rule becomes:

if T₁<x<T₂ decide w₁

if x<T₁ or x>T₂ decide w₂

T₁ and T₂ are the two solutions of the following quadratic equation which is the solution of the decision rule in equality:

$${T}_{1.2}^{2} ( {σ}_{2}^{2} - {σ}_{1}^{2} ) + {T}_{1.2} ( - 2 {σ}_{2}^{2} {μ}_{1} + 2 {σ}_{1}^{2} {μ}_{2} ) + {σ}_{2}^{2} {μ}_{1}^{2} - {σ}_{1}^{2} {μ}_{2}^{2} - 2 log \frac{{σ}_{2}}{{σ}_{1}} = 0$$

and T₂>T₁.

However, in the problem being considered the conditional distributions p(x|w₁) and p(x|w₂) are not known in advance. They are assumed to belong to a parametric family, and the parameters are estimated given a training set. The training set consists of independent, identically distributed (i.i.d.) samples: x¹=(x₁¹, . . . , xₙ¹) correspond to w₁, and x²=(x₁², . . . , xₙ²) correspond to w₂. Assume also that n→∞.

Now, since discriminative training claims to be better when the assumed model is incorrect, an incorrect assumption is made about the model, which is that both classes have the same variance: σ₁²=σ₂²=σ². The goal is to calculate the estimates for the means, μ₁ and μ₂. Assuming equal variances and \hat{μ}₁<\hat{μ}₂, the MAP decision rule becomes:

$${x}_{< {w}_{1}}^{> {w}_{2}} T = \frac{{\hat{μ}}_{1} + {\hat{μ}}_{2}}{2}$$

Note that the decision rule is independent of the variance, therefore the variance will not be estimated.

The ML solution provides the following answer. The ML estimates in the current case are simple averages of the samples:

$${\hat{μ}}_{1} = \frac{1}{n} {\sum }_{i = 1}^{n} {x}_{i}^{1} and {\hat{μ}}_{2} = \frac{1}{n} {\sum }_{i = 1}^{n}$$

xᵢ². According to the law of large numbers n→∞ assures that \hat{μ}₁→−μ, \hat{μ}₂→μ, and T→0 (convergence is in the Mean Square sense).

To obtain an answer according to the approximated MMI criteria, start from the threshold obtained by the ML solution: T₀=0. Maximization of the objective function yields the following formulas:

$${\hat{μ}}_{1} = \frac{{\sum }_{i = 1}^{n} {x}_{i}^{1} - λ {\sum }_{{x}_{i}^{1} \vert {x}_{i}^{1} < {T}_{0}} {x}_{i}^{1} - λ {\sum }_{{x}_{i}^{2} \vert {x}_{i}^{2} < {T}_{0}} {x}_{i}^{2}}{n - λ {\sum }_{{x}_{i}^{1} \vert {x}_{i}^{1} < {T}_{0}} 1 - λ {\sum }_{{x}_{i}^{2} \vert {x}_{i}^{2} < {T}_{0}}}$$

$${\hat{μ}}_{2} = \frac{{\sum }_{i = 1}^{n} {x}_{i}^{2} - λ {\sum }_{{x}_{i}^{1} \vert {x}_{i}^{1} > {T}_{0}} {x}_{i}^{1} - λ {\sum }_{{x}_{i}^{2} \vert {x}_{i}^{2} > {T}_{0}} {x}_{i}^{2}}{n - λ {\sum }_{{x}_{i}^{1} \vert {x}_{i}^{1} > {T}_{0}} 1 - λ {\sum }_{{x}_{i}^{2} \vert {x}_{i}^{2} > {T}_{0}} 1}$$

Assuming n→∞, the law of large numbers can be applied, and the following features can be used:

$${\sum }_{i = 1}^{n} {x}_{i} \to E ( x )$$

$${\sum }_{{x}_{i} \vert {x}_{i} < T} 1 \to nP ( x < T )$$

$${\sum }_{{x}_{i} \vert {x}_{i} < T} {x}_{i} \to nP ( x < T ) E ( x \vert x < T )$$

$${\sum }_{{x}_{i} \vert {x}_{i} > T} 1 \to nP ( x > T )$$

$${\sum }_{{x}_{i} \vert {x}_{i} > T} {x}_{i} \to nP ( x > T ) E ( x \vert x > T )$$

The probability of error is given by the formula:

$${P}_{error} = \frac{1}{2} \{ P ( x > {T}_{MMI} \vert {w}_{1} ) + P ( x < {T}_{MMI} \vert {w}_{2} ) \}$$

The above problem was simulated by MATLAB, with the following values: μ₁=−3, μ₂−3, σ₁²=1, σ₂²=4. The estimates were calculated using their asymptotic value. \hat{μ}₁, \hat{μ}₂, the threshold

$${T}_{MMI} = \frac{{\hat{μ}}_{1} + {\hat{μ}}_{2}}{2}$$

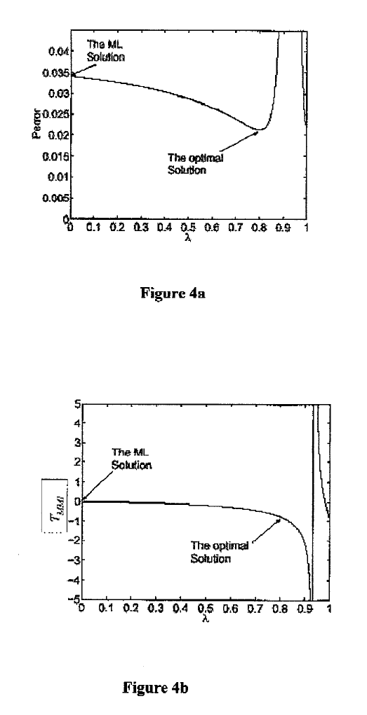

and the corresponding probability of error were calculated for various values of λ. Experimental results, for system performance using a training process based on the approximated MMI objective function, are shown in FIGS. 4a and 4b. FIG. 4a shows the behavior of the threshold Pₑᵣᵣₒᵣ as a function of the parameter λ, and FIG. 4b shows the behavior of T_{MMI} as a function of the parameter λ. It can be seen that for sufficiently small values of λ, Pₑᵣᵣₒᵣ is smaller than the one obtained by ML estimation. Further iterations were also simulated, but did not yield a consistent improvement in the probability of error.

As shown above, finding the approximated MMI estimates is performed by maximizing the J_{λ}(θ) function (or the J_{λ}^{v}(θ) functions separately). In some statistical models, such as the HMM model, the target function cannot be maximized directly due to the nature of the pdf of the model. However, the approximated MMI target function may be maximized by a method similar to the Estimate-Maximize (EM) algorithm discussed above. The maximization process may be formulated as follows.

Assume a training set comprising the elements (y¹, . . . , y^{U}) with the probability density function f_{Y}(y;θ). Assume also the existence of complete data x^{u} corresponding to y^{u}, with the pdf f_{X}(x;θ), where y^{u}=H(x^{u}) and H(.) is a non-invertible (many-to-one) transformation. Maximizing the target function is performed by maximizing the following function:

$${J}_{v} ( θ ) - {\sum }_{u ∈ {A}_{v}} log {f}_{γ} ( {y}^{u} ; θ ) - λ {\sum }_{u ∈ {B}_{v}} log {f}_{γ} ( {y}^{u} ; θ )$$

where:

f_{X}(x^{u};θ)=f_{Y}(y^{u};θ)f_{X|Y}(x^{u}|y^{u};θ) ∀x^{u},y^{u}|H(x^{u})=y^{u}

and:

log f_{Y}(y^{u};θ)=log f_{X}(x^{u};θ)−log f_{X|Y}(x^{u}|y^{u};θ) ∀x^{u},y^{u}|H(x^{u})=y^{u}

Rewriting Jᵥ(θ) and taking the conditional expectation E_{θ′}(.|y¹, . . . , y^{U}) obtain:

$$\begin{matrix}{J}_{v} ( θ ) = \{ {\sum }_{u ∈ {A}_{v}} {E}_{{0}^{′}} \{ log {f}_{X} ( {x}^{u} ; θ ) \vert {y}^{u} \} - λ {\sum }_{u ∈ {B}_{v}} {E}_{{θ}^{′}} \{ log {f}_{X} ( {x}^{u} ; θ ) \vert {y}^{u} \} - \\ \{ {\sum }_{u ∈ {A}_{v}} {E}_{{θ}^{′}} \{ log {f}_{X \vert Y} ( {x}^{u} \vert {y}^{u} ; θ ) \vert {y}^{u} \} - \\ λ {\sum }_{u ∈ {B}_{v}} {E}_{{θ}^{′}} \{ log {f}_{X \vert Y} ( {x}^{u} \vert {y}^{u} ; θ ) \vert {y}^{u} \} \} {△}_{=} \\ Q ( θ , {θ}^{′} ) - H ( θ , {θ}^{′} )\end{matrix}$$

So, as with the Estimate-Maximize (EM) algorithm, a two step iterative solution can be formulated as:

E-Step

Compute an auxiliary function:

$$Q ( θ , {θ}^{( l )} ) = {\sum }_{u ∈ {A}_{v}} {E}_{{θ}^{( l )}} \{ log {f}_{X} ( {x}^{u} ; θ ) \vert {y}^{u} \} - λ {\sum }_{u ∈ {B}_{v}} {E}_{{θ}^{( l )}} \{ log {f}_{X} ( {x}^{u} ; θ ) \vert {y}^{u} \}$$

M-Step

Maximize:

θ^{(l+1)}=arg max_{θ} Q(θ,θ^{(l)})

where θ^{(l)} equals the estimate of the parameter set θ at step l of the maximization process. The experimental results given below demonstrate that the algorithm increases the objective function.

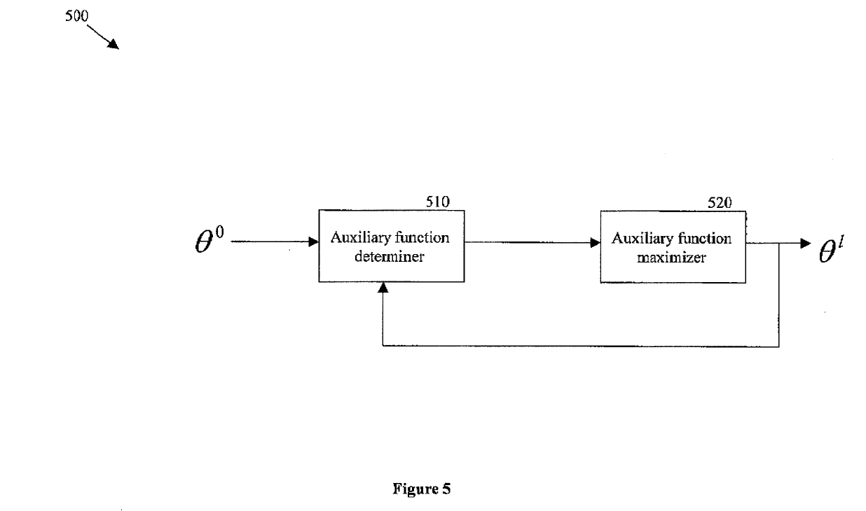

Reference is now made to FIG. 5, which is a simplified block diagram of a preferred embodiment of a maximizer 500. The embodiment of FIG. 5 is based on the EM solution discussed above. Maximizer 500 is an iterative device comprising auxiliary function determiner 510 and auxiliary function maximizer 520. Auxiliary function determiner 510 forms an auxiliary function associated with the target function using the current estimate of the set of parameters, and auxiliary function maximizer 520 updates the set of parameters parameter values which maximize the auxiliary function. Initial values for the parameter set may be provided by an initial estimator, as discussed above. In the preferred embodiment, the initial estimate is a maximum likelihood estimate.

In the preferred embodiment the auxiliary function, for all elements of the predetermined group of elements, is:

$${\sum }_{v = 1}^{V} \{ {\sum }_{u ∈ {A}_{v}} {E}_{{θ}^{( l )}} \{ log {f}_{X} ( {x}^{u} ; θ ) \vert {y}^{u} \} - λ {\sum }_{u ∈ {B}_{v}} {E}_{{θ}^{( l )}} \{ log {f}_{X} ( {x}^{u} ; θ ) \vert {y}^{u} \} \}$$

as shown above. θ^{(l)} is an estimate of the set of parameters at step l, and E_{θ}_{^{(l)}}{.|y^{u}} is a conditional expected value function conditional upon member y^{u} of the training set using the estimate of parameter set at step l, and all other parameters are as defined above. x^{u} is the u^{th} member of a second data set associated with the training data set. The second data set may be a complete data set.

The auxiliary function can also be defined more generally as a summation, over the elements of the predetermined group of elements, of a difference between a first summation of conditional expected value functions as a function of the set of parameters, and a second summation, of conditional expected value functions as a function of the set of parameters, multiplied by a discrimination rate. As previously the discrimination rate range is between zero and one.

The above maximization algorithm can be applied to the HMM statistical model. Let Qᵥ be the auxiliary function corresponding to J_{λ}^{v}(θ):

$$\begin{matrix}{Q}_{v} ( \overline{θ} , θ ) = {\sum }_{m ∈ v} \{ {\sum }_{u ∈ {A}_{v}} {p}_{θ} ( m \vert {O}^{u} , v ) log {p}_{\overline{θ}} ( m , {O}^{u} \vert v ) - \\ λ {\sum }_{u ∈ {B}_{v}} {p}_{θ} ( m \vert {O}^{u} , v ) log {p}_{\overline{θ}} ( m , {O}^{u} \vert v ) \}\end{matrix}$$

where m=(s₀, . . . , s_{T+1}, g₁, . . . , g_{T}) denotes the complete underlying sequence of states and mixtures.

The M-step maximizes Qᵥ(\overline{θ},θ) with respect to all the elements of the parameter vector θ. After the maximization is performed the following re-estimation formulas are obtained:

$${\overline{a}}_{ij} = \frac{\begin{matrix}{\sum }_{u ∈ {A}_{v}} {\sum }_{t = 0}^{{T}^{u}} {p}_{θ} ( {s}_{i} = i , {s}_{i + 1} = j \vert {O}^{u} , v ) - \\ λ {\sum }_{u ∈ {B}_{v}} {\sum }_{t = 0}^{{T}^{u}} {p}_{0} ( {s}_{i} = i , {s}_{i + 1} = j \vert {O}^{u} , v )\end{matrix}}{{\sum }_{u ∈ {A}_{v}} {\sum }_{t = 0}^{{T}^{u}} {ψ}_{ik}^{u} ( t ) - λ {\sum }_{u ∈ {B}_{v}} {\sum }_{t = 0}^{{T}^{u}} {ψ}_{ik}^{u} ( t )}$$

$${\overline{c}}_{ik} = \frac{{\sum }_{u ∈ {A}_{v}} {\sum }_{t = 1}^{{T}^{u}} {ψ}_{ik}^{u} ( t ) - λ {\sum }_{u ∈ {B}_{v}} {\sum }_{t = 1}^{{T}^{u}} {ψ}_{ik}^{u} ( t )}{{\sum }_{u ∈ {A}_{v}} {\sum }_{t = 1}^{{T}^{u}} {ψ}_{i}^{u} ( t ) - λ {\sum }_{u ∈ {B}_{v}} {\sum }_{t = 1}^{{T}^{u}} {ψ}_{i}^{u} ( t )}$$

$${\ddot{u}}_{ikj} = \frac{{\sum }_{u ∈ {A}_{v}} {\sum }_{t = 1}^{{T}^{u}} {{ψ}_{ik}^{u} ( t ) [ {o}_{t}^{u} ]}_{j} - λ {\sum }_{u ∈ {B}_{v}} {\sum }_{t = 1}^{{T}^{u}} {{ψ}_{ik}^{u} ( t ) [ {o}_{t}^{u} ]}_{j}}{{\sum }_{u ∈ {A}_{v}} {\sum }_{t = 1}^{{T}^{u}} {ψ}_{ik}^{u} ( t ) - λ {\sum }_{u ∈ {B}_{v}} {\sum }_{t = 1}^{{T}^{u}} {ψ}_{ik}^{u} ( t )}$$

$${\overline{σ}}_{ikj} = \frac{{\sum }_{u ∈ {A}_{v}} {\sum }_{t = 1}^{{T}^{u}} {ψ}_{ik}^{u} ( t ) {( {[ {o}_{t}^{u} ]}_{j} - {\overline{μ}}_{ikj} )}^{2} - λ {\sum }_{u ∈ {B}_{v}} {\sum }_{t = 1}^{{T}^{u}} {ψ}_{ik}^{u} ( t ) {( {[ {o}_{t}^{u} ]}_{j} {\overline{μ}}_{ikj} )}^{2}}{{\sum }_{u ∈ {A}_{v}} {\sum }_{t = 1}^{{T}^{u}} {ψ}_{ik}^{u} ( t ) - λ {\sum }_{u ∈ {B}_{v}} {\sum }_{t = 1}^{{T}^{u}} {ψ}_{ik}^{u} ( t )}$$

Comparing the formulas for the ML estimates to the approximated MMI results, it is possible to describe the re-estimation procedure in the following way:

For an HMM parameter, b, the ML re-estimation formula takes the form

$${\overline{b}}_{ML} - \frac{N ( b )}{D ( b )} .$$

N(b) and D(b) are referred to as the accumulators. Calculate N(b) and D(b) according to the set Aᵥ, the original transcription of the training set.

Calculate N_{D}(b) and D_{D}(b) of the ML estimate using the utterances in the set Bᵥ, the transcription obtained by recognition. N_{D}(b) and D_{D}(b) are referred to as the discriminative accumulators.

Calculate the new parameter estimates \overline{b} according to the following formula:

$$\overline{b} = \frac{N ( b ) - λ {N}_{D} ( b )}{D ( b ) - λ {D}_{D} ( b )}$$

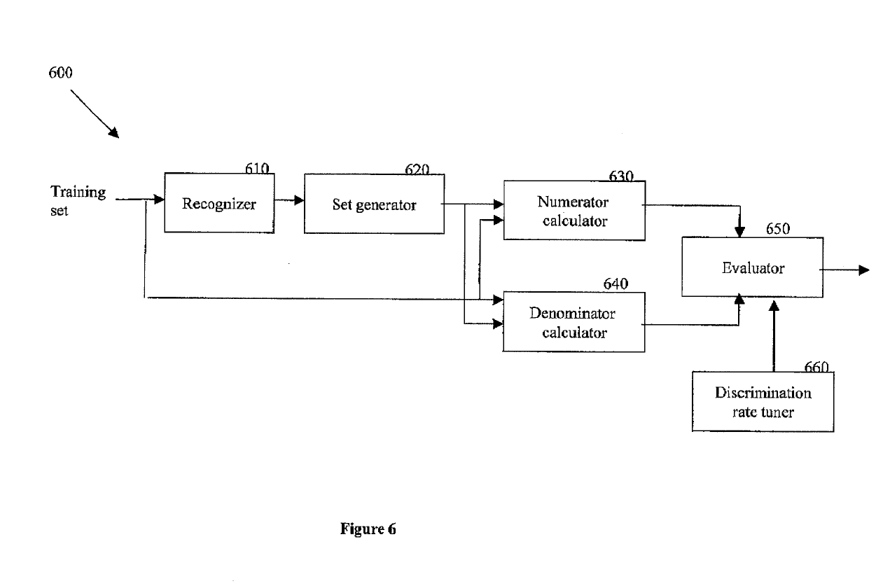

Reference is now made to FIG. 6, which is a simplified block diagram of an alternate preferred embodiment of a parameter estimator 600 for estimating a set of parameters. The embodiment of FIG. 6 calculates the accumulators and discriminative accumulators for the parameter set, and uses the accumulators to estimate the parameters. Parameter estimator 600 consists of a recognizer 610, a set generator 620, numerator calculator 630, denominator calculator 640, and evaluator 650. In the preferred embodiment, the estimated parameters are parameters of a statistical model, such as the HMM, Gaussian, and Gaussian mixture models. In the preferred embodiment, parameter estimator 600 also contains discrimination rate tuner 660 for tuning the discrimination rate between 0 and 1, as described above.

Recognizer 610 and set generator 620 process the training set members as described above, to recognize training set members and to generate the equivalence sets. Numerator calculator 630 then calculates a numerator accumulator, N(b), and a discriminative numerator accumulator, N_{D}(b), for each parameter b. Denominator calculator 630 then calculates a denominator accumulator, D(b), and a discriminative denominator accumulator, D_{D}(b), for each parameter b. Evaluator 650 calculates an approximated MMI estimate of parameter b as:

$$\overline{b} = \frac{N ( b ) - λ {N}_{D} ( b )}{D ( b ) - λ {D}_{D} ( b )}$$

where λ is the discrimination rate, which varies between 0 and 1.

In the preferred embodiment, the accumulators for a given parameter are calculated according to the maximum likelihood accumulator estimate of the parameter. However, the discriminative accumulators are calculated over the equivalence sets, Bᵥ, whereas the accumulators are calculated over the Aᵥ sets. For example, for the HMM model the maximum likelihood numerator accumulator for the transition probability from state i to state j, aᵢⱼ, is calculated as:

$$N ( {a}_{ij} ) = {\sum }_{u ∈ {A}_{v}} {\sum }_{t = 0}^{{T}^{u}} {p}_{0} ( {s}_{i} = i , {s}_{t + 1} = j \vert {O}^{u} , v )$$

and the maximum likelihood denominator accumulator is calculated as:

$$D ( {a}_{ij} ) = {\sum }_{u ∈ {A}_{v}} {\sum }_{t = 0}^{{T}^{u}} {ψ}_{i}^{u} ( t ) .$$

Thus the discriminative numerator accumulator for aᵢⱼ, is calculated as:

$${N}_{D} ( {a}_{ij} ) = {\sum }_{u ∈ {B}_{v}} {\sum }_{t = 0}^{{T}^{u}} {p}_{0} ( {s}_{i} = i , {s}_{t + 1} = j \vert {O}^{u} , v )$$

and the discriminative denominator accumulator is calculated as:

$${D}_{D} ( {a}_{ij} ) = {\sum }_{u ∈ {B}_{v}} {\sum }_{t = 0}^{{T}^{u}} {ψ}_{i}^{u} ( t ) .$$

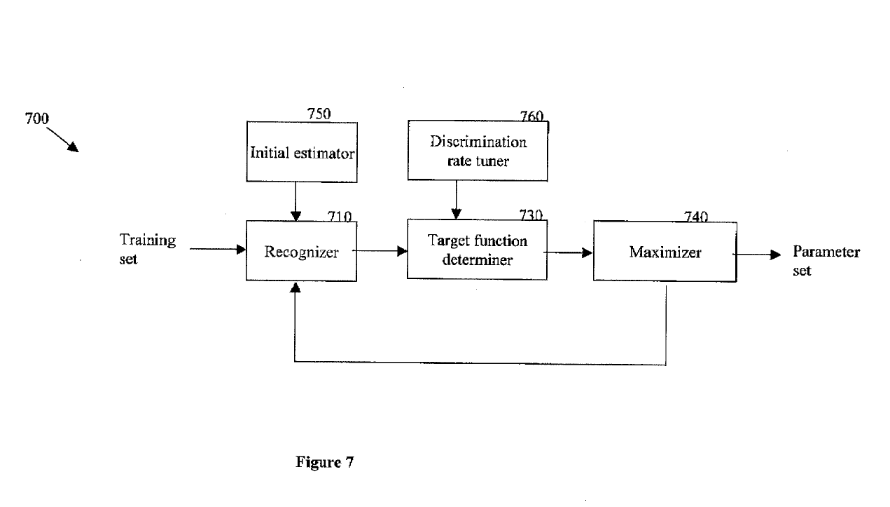

A preferred embodiment of the parameter estimator is for a word-spotting pattern recognition task. Reference is now made to FIG. 7, which is a simplified block diagram of a preferred embodiment of a parameter estimator 700 for estimating a set of parameters for word-spotting pattern recognition. Parameter estimator 700 consists of recognizer 710, target function determiner 730, and maximizer 740. Recognizer 710 receives training set members and performs recognition on the members using a current set of parameters, to transcribe the members into a recognized transcription. The target function determiner 730 then calculates a target function using at least one of the recognized transcriptions. The target function is calculated using the current estimated value of the set of parameters. Maximizer 740 maximizes the target function, and updates the set of parameters to the values which bring the target function to its maximum value.

A word spotter identifies keywords within an input sequence. In the baseline word-spotter discussed above, the speech signal passes through two transcribers: a first transcriber containing a keyword and filler model, and a second transcriber containing only the filler models. Each channel outputs a transcription and its corresponding score. The segments that are recognized as keywords by the first recognizer are referred to as putative hits. Each putative hit is given a final score calculated using the two scores given by the recognizers. The final score is then compared to a threshold according to which the putative hits are reported as hits or as false alarms. The parameter set for the keyword and filler transcriber is provided by a parameter estimator, as described above, where the recognizer in the parameter estimator uses the keyword and filler statistical model in order to perform recognition on the training set.

The word-spotting target functions are formulated similarly to the target functions given above. In a generalized formulation, the word-spotting target function is a difference between a logarithm of a first probability density function as a function of the set of parameters, and a logarithm of a second probability density function as a function of the set of parameters, multiplied by a discrimination rate which varies between zero and one.

In a second formulation, the preferred embodiment for the target function is:

J_{λ}(θ)=log p_{θ}(O|W)−λ log p_{θ}(O|Ŵ)

where Ŵ corresponds to the largest term in the sum of the MMI criterion:

$$M ( θ ) = log p ( W ) {p}_{θ} ( O \vert W ) - log {\sum }_{{allW}^{′}} p ( {W}^{′} ) {p}_{θ} ( O \vert {W}^{′} )$$

where the sum is over all possible transcriptions.

Ŵ may be found by using the keyword+filler recognizer on the training set. From Ŵ it is possible to obtain the sets of indices Bᵥ corresponding to the places where each word v was recognized, and where Aᵥ are the sets of indices according to the given transcription, as discussed above. It is then possible to use the Aᵥ and Bᵥ sets in order to re-estimate the parameters of the keywords as described above.

Note that in order to obtain the Bᵥ sets, recognition is performed on the training set using a KW+filler recognizer. As discussed above, false alarms can be reduced using scoring. Two variants of the algorithm are discussed below:

First variant: use all false alarms for discrimination.

Second variant: use only a part of the false alarms (according to their score) for discrimination.

Experimental results for the word-spotting embodiment are given below.

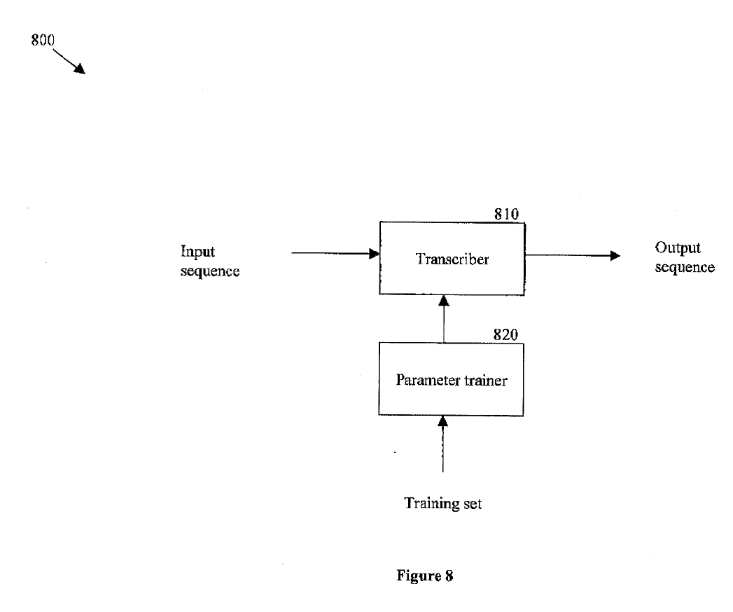

Reference is now made to FIG. 8, which is a simplified block diagram of a preferred embodiment of a pattern recognizer 800 for performing statistical pattern recognition upon an input sequence. Pattern recognizer 800 transcribes the input sequence into an output sequence, where the output sequence consists of elements from a predetermined group of elements. The pattern recognizer consists of a transcriber 810, which performs the transcription according to a predetermined statistical model having a set of parameters, and a parameter estimator 820, which provides the set of parameters used by the transcriber. Parameter estimator 820 operates as described above.

The input and/or output sequences may consist of isolated or continuous sequences. For example, in a speech recognition system the speech input may be isolated utterances or continuous speech.

In a preferred embodiment the statistical pattern recognition system is a speech recognizer. The speech recognizer performs statistical speech processing upon an input sequence of utterances, and transcribes the input sequence into an output sequence comprising words from a predetermined vocabulary.

In a preferred embodiment, the speech recognizer also includes a converter for converting the input sequence of utterances into a sequence of samples representing a speech waveform.

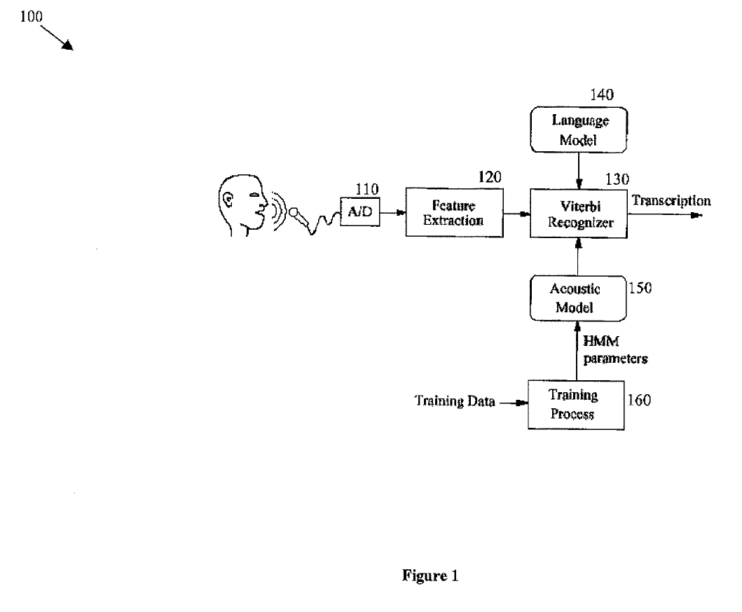

In a preferred embodiment, the speech recognizer also includes a feature extractor which reduces the dimension of the sample sequence by extracting a feature vector, as described above for the speech recognizer of FIG. 1. The feature extraction can be performed by any method known in the art. The feature vector is then processed by the transcriber. The reduced transcriber input dimension may simplify the transcription process.

In a preferred embodiment, the speech recognizer also includes a language modeler which provides grammatical constraints to the transcriber.

In a preferred embodiment, the speech recognizer also includes an acoustic modeler for embedding acoustic constraints into the statistical model.

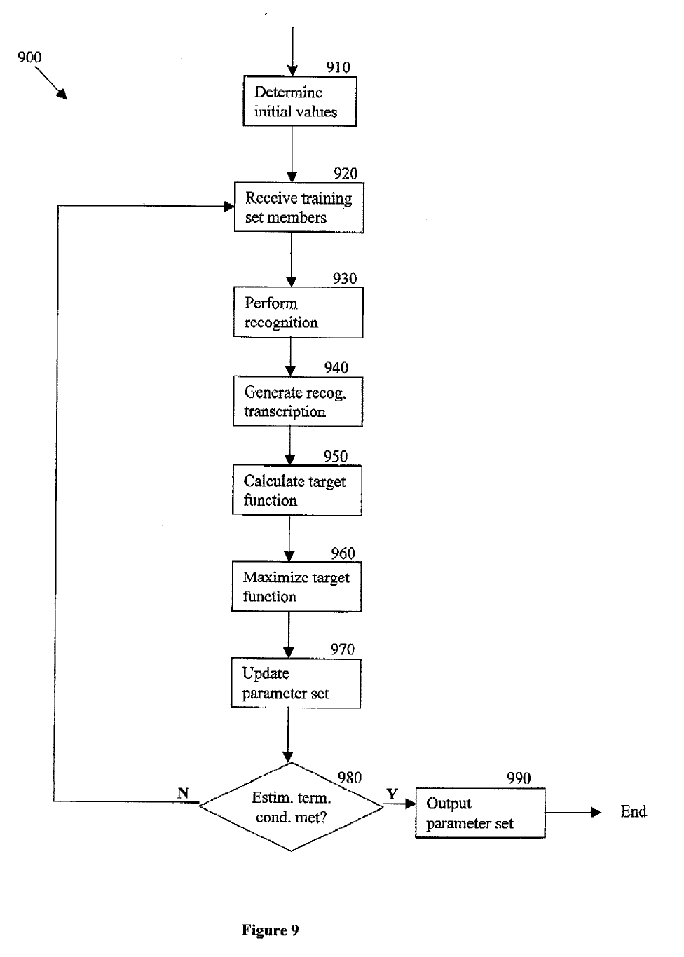

Reference is now made to FIG. 9, which is a simplified flow chart of a method for estimating a set of parameters for insertion into a statistical pattern recognition process. In step 910 initial values are determined for the parameter set. In the preferred embodiment, the initial values may be determined by performing maximum likelihood estimation. An estimation cycle is then performed.

The estimation cycle consists of the following steps. A training set is received in step 920. In step 930, recognition is performed on the members of the training set using a current set of parameters. The training set members are recognized as elements of a predetermined group of elements. Recognition may be performed by any recognition method known in the art. The results of the recognition step are used in step 940 to generate at least one equivalence set comprising recognized members of the training set. In step 950, the equivalence sets and the set of parameters are used to calculate a target function. The target function is maximized with respect to the set of parameters in step 960, and in step 970 the parameter set is updated to the values found to maximize the target function.

In step 980, a decision step is reached. If the set of parameters satisfies a predetermined estimation termination condition, such as a predetermined recognition error rate, the parameters are output in step 990 and the parameter estimation method is ended. Otherwise, another estimation cycle is performed.

In a preferred embodiment, the recognition is performed on the same training set members over more than one iteration. For example the training set members may be received only once, before entering the estimation cycle loop, and the recognition performed on the same training set for all estimation cycles.

In the preferred embodiment, the target function is a summation, over the elements of the predetermined group of elements, of a difference between a first summation of logarithms of probability density functions as a function of the set of parameters, and a second summation, of logarithms of probability density functions as a function of the set of parameters, multiplied by a discrimination rate. The discrimination rate is variable between zero and one.

In a further preferred embodiment, the target function is:

$${\sum }_{v = 1}^{V} \{ {\sum }_{u ∈ {A}_{v}} log {p}_{θ} ( {O}^{u} \vert v ) - λ {\sum }_{u ∈ {B}_{v}} log {p}_{0} ( {O}^{u} \vert v ) \}$$

where v is an element of the predetermined group of elements, V is the number of elements of said predetermined group of elements, u is the index of a member of the training set, Aᵥ is a set of indices of members of the training set corresponding to element v, Bᵥ is a set of indices of members of the training set corresponding to an equivalence set associated with element v, O^{u} is a u^{th} member of the training set, λ is the discrimination rate, θ is the set of parameters, and p_{θ}(.|v) is a predetermined probability density function of element v using the set of parameters.

In the preferred embodiment, the method has the further step of tuning the discrimination rate. The discrimination rate may be tuned to optimize some predetermined criterion, such as the recognition error rate. The discrimination rate may be tuned to a constant value for all training set members and for all estimation cycles, or it may be tuned to different levels for different members or over different estimation cycles.

In the preferred embodiment, the method has a further step of providing at least some of the updated parameter set to a statistical pattern recognition process. The pattern recognition process may use the parameter set for performing pattern recognition, such as speech processing, over real input sets. Other types of statistical pattern recognition for which the method may be used include: image recognition, decryption, communications, sensory recognition, optical, optical character recognition (OCR), natural language processing (NLP), gesture and object recognition (for machine vision), text classification, and control processes.

In the preferred embodiment, the statistical pattern recognition process is a speech recognition process, the members of the training set comprise utterances, and the predetermined group of elements is a predetermined vocabulary of words.

In the preferred embodiment, the statistical process uses a hidden Markov model (HMM). The HMM may be an effective model for a speech recognition process, and is often used in speech recognition systems.

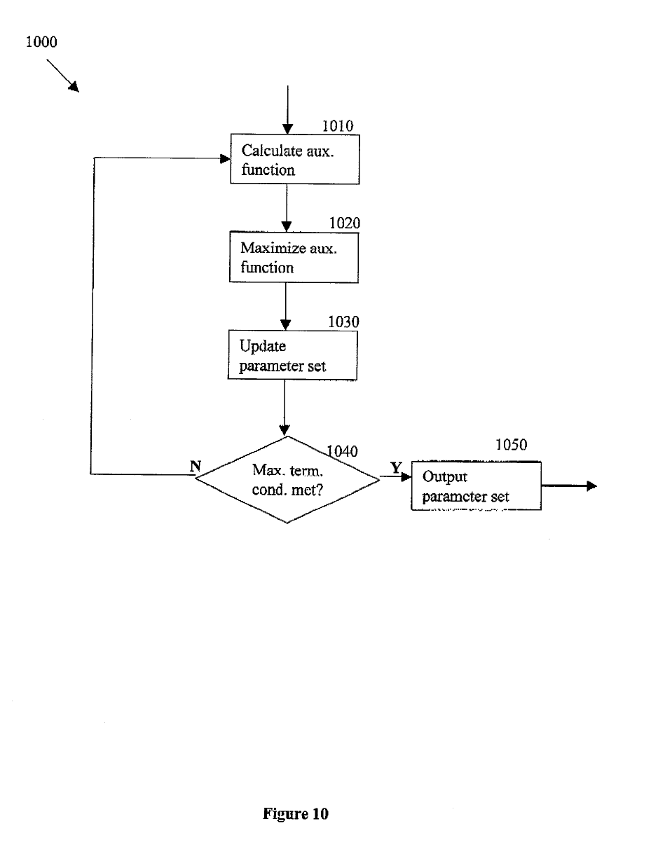

Reference is now made to FIG. 10, which is a simplified flow chart of a method for maximizing the target function with respect to the set of parameters. The method begins by performing a first maximization cycle.

A maximization cycle consists of the following steps. In step 1010 a current estimate of the set of parameters is used to calculate an auxiliary function associated with the target function. In step 1020, the auxiliary function is maximized with respect to the set of parameters. The set of parameters is updated in step 1030, to maximize the target function.

In step 1040, a predetermined maximization termination condition is checked. If the set of parameters satisfies a predetermined maximization termination condition, the parameters are output in step 1050 and the parameter maximization is ended. Otherwise another maximization cycle is performed.

In a preferred embodiment, the auxiliary function is a summation, over the elements of the predetermined group of elements, of a difference between a first summation of conditional expected value functions as a function of the set of parameters, and a second summation, of conditional expected value functions as a function of the set of parameters, multiplied by a discrimination rate, the discrimination rate being variable between zero and one.

In a further preferred embodiment, the auxiliary function is:

$${\sum }_{v = 1}^{V} \{ {\sum }_{u ∈ {A}_{v}} {E}_{{0}^{( l )}} \{ log {f}_{X} ( {x}^{u} ; θ ) \vert {y}^{u} \} - λ {\sum }_{u ∈ {B}_{v}} {E}_{{θ}^{( l )}} \{ log {f}_{X} ( {x}^{u} ; θ ) \vert {y}^{u} \} \}$$

wherein l is a step number, 0^{(l)} an estimate of the set of parameters at step l, y^{u} is a u^{th} member of the training set, x^{u} is a u^{th} member of a second data set associated with the training set, f_{X}(x^{u};θ) is a predetermined probability density function of data member x^{u} of the second data set using the set of parameters, and E_{θ}_{^{(l)}}{.|y^{u}} is a conditional expected value function conditional upon member y^{u} of the training set using the estimate of the set of parameters at step l. The second data set may be a complete data set.

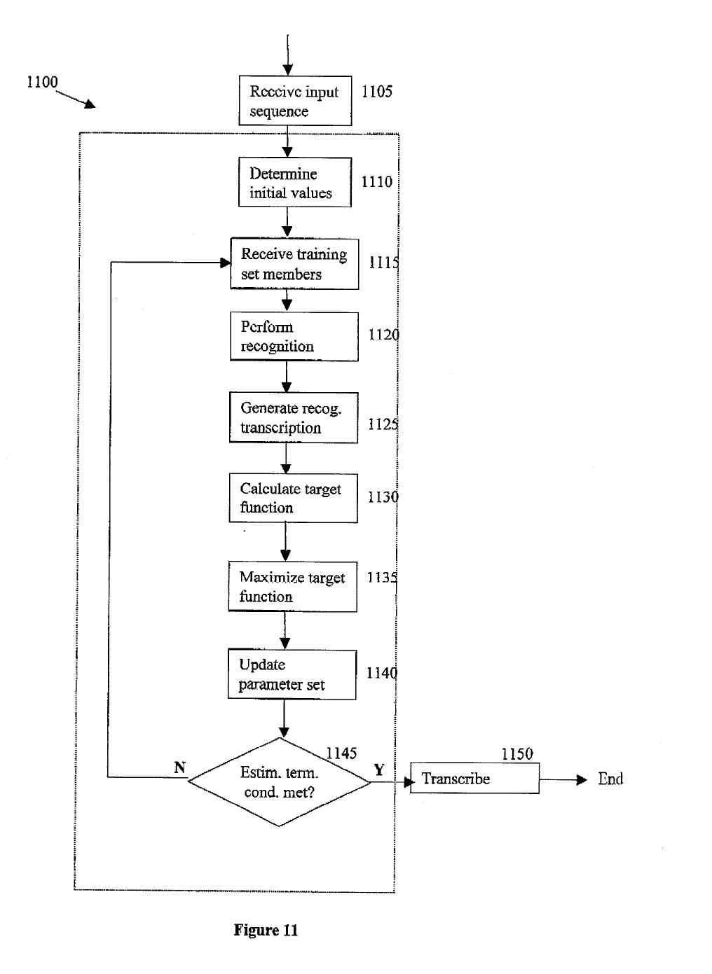

Reference is now made to FIG. 11, which is a simplified flow chart of a method for performing statistical pattern recognition upon an input test sequence. The pattern recognition process transcribes the test sequence into a recognized output sequence, where the output sequence consists of a series of elements, such as words, taken from a limited set of known elements. In step 1105 the input sequence is received. In steps 1110 to 1145 the parameter set is estimated as described above. In step 1150 the estimated parameter set is inserted into the statistical model and used to transcribe the input sequence into an output sequence.

In addition to the approximated MMI objective function, a second objective function was developed, based upon an algorithm designated the mixture algorithm. In the mixture algorithm the right hand sum of the MMI objective function is not approximated (as in the approximated MMI algorithm), but is regarded as a mixture of word models. The mixture objective function is optimized in a similar manner as the optimization of the approximated MMI objective function, where the complete data of the mixture comprises the state and the word in each time instance.

The objective function for the mixture algorithm is:

$$M ( θ ) = {\sum }_{u = 1}^{U} \{ log [ p ( v ) {p}_{θ} ( {O}^{u} \vert {w}^{u} ) ] - λlog {\sum }_{v = 1}^{V} [ p ( v ) {p}_{θ} ( {O}^{u} \vert v ) ] \}$$

with 0≦λ≦1.

For the mixture algorithm, it was assumed that λ is sufficiently small, so that a maximization of the auxiliary function can lead to a growth of the objective function. The re-estimation formulas are similar to the one described above, the difference being that the sums with the negative signs are not over the Bᵥ sets, but over all the utterances in the training set.

Experimental results show that the mixture algorithm requires a very small value of λ in order to keep parameters from obtaining illegal values. In cases where λ is small enough, the improvement obtained by the algorithm is negligible. The limitation on λ may be a result of the crudeness of the assumptions used to derive the mixture objective function.

Experimental results were also obtained for the approximated MMI objective function for several speech recognition tasks. Results are presented below for a first task of recognition in a noisy environment of isolated digits taken from the TIDIGITS database, and for a second task of phoneme recognition on the TIMIT database.

The TIDIGITS corpus is a multi-speaker small vocabulary database. The corpus vocabulary consists of 11 words (the digits ‘1’ to ‘9’ plus ‘oh’ and ‘zero’) spoken by 326 speakers, in both an isolated and a continuous manner. Due to the fact that the continuous utterances are not segmented, and that the approximated MMI algorithm requires the training set to be segmented, only the utterances of isolated digits were used. The training set used in the experiments contained 113 speakers (55 men, 58 women), and the test set comprised 115 speakers (57 men, 58 women). Each speaker spoke each digit twice. Only the adult speakers of the corpus were used.

Isolated digit recognition on the TIDIGITS database is a relatively easy task. Very high recognition rates (99.80% in the experiments) can be obtained using a Gaussian mixture HMM speech recognizer trained using ML. In order to demonstrate the improvement yielded by the approximated MMI algorithm, the recognition rate was deliberately reduced. This was done by adding white Gaussian noise whose variance is equal to the signal's power to all the speech files (thus obtaining a low signal to noise ratio, equal to 0 dB), and by using HMMs with only one Gaussian mixture.

The speech recognition system was based on the HTK Hidden Markov model toolkit (http://htk.eng.cam.ac.uk). The feature vector comprised 12 Mel-frequency cepstral coefficients, log energy coefficient and their corresponding delta and acceleration coefficient (a total number of 39 features). The speech was analyzed at a 10 ms frame rate with a window size of 25 ms. Mean normalization was applied to the feature vectors of each speech file separately. Each digit, including the silence segments surrounding it, was modeled by a HMM with 10 emitting states, with diagonal covariance, single mixture Gaussian output distributions. The HMM topology was left to right with no skips. A baseline (ML) system was obtained by using three iterations of the segmental k-means algorithm for parameter initialization, and seven iterations of the Baum-Welch algorithm for the ML parameter estimation. A null-grammar Viterbi recognizer was used for recognition, i.e. an equal prior probability to all digits was assumed. The recognition rate of the system was 88.58%.

The value of the parameters after ML estimation was taken as the initial value of the discriminative algorithm. Initial experiments on both the TIMIT and TIDIGITS tasks led to the following conclusions:

The mixture algorithm described above did not seem to yield a significant improvement over the ML baseline. No further experiments were conducted using the mixture algorithm.

For large values of λ, variances and transition probabilities tended to become negative. In these cases, they were replaced by their ML values. However, when such an event occurred, the recognition rate deteriorated drastically. So, in further experiments, λ values were chosen to be sufficiently small.

Updating all types of parameters (means, variances, transition probabilities and mixture weights) always yielded better results than updating only part of them.

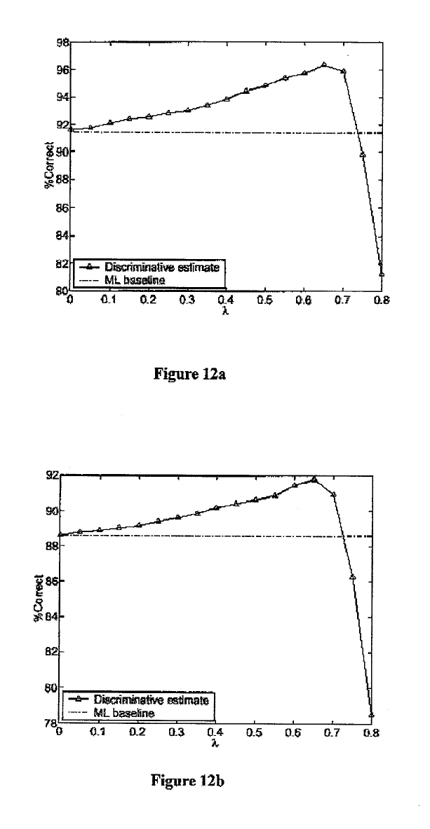

In light of the above conclusions, in further experiments all the parameters were updated, and different values of λ were chosen. FIG. 12a shows the recognition rate on the training set after one iteration of the algorithm as a function of λ. The same value of λ was used in the experiment in the estimation of all the words in the vocabulary. FIG. 12b shows the corresponding recognition rate on the test set.

The main results for the approximated MMI embodiment after the first iteration were:

The best improvement yielded by the algorithm on the test set, is a reduction of 28% in the error rate (a growth in the recognition rate from 88.58% to 91.79%). The corresponding reduction in the error rate on the training set is 56% (a growth in the recognition rate from 91.60% to 96.31%).

On both the training and test sets, the best improvement was for λ=0.65. The result shows that the training set gives a good representation of the acoustic events of the test set. In light of the result, in the case of the TIDIGITS database, the choice of λ can be made by its optimization according to the recognition results on the training set.

Another experiment was conducted by applying several iterations of the algorithm with the same value of λ. In each iteration the following criteria were calculated:

The recognition rate on the training set.

The MMI objective function

$$M ( θ ) = {\sum }_{u = 1}^{U} \{ log \vert p ( {w}^{u} ) {p}_{θ} ( {O}^{u} \vert {w}^{u} ) ] - log {\sum }_{v = 1}^{V} [ p ( v ) {p}_{0} ( {O}^{u} \vert v ) ] \}$$

The MMI objective function under the approximation log ΣXᵢ≈log{max Xᵢ}:

$${M}^{*} ( θ ) = {\sum }_{u = 1}^{U} \{ log [ p ( {w}^{u} ) {p}_{θ} ( {O}^{u} \vert {w}^{u} ) ] - log {max}_{v} [ p ( v ) {p}_{θ} ( {O}^{u} \vert v ) ] \}$$

The objective function of the approximated MMI algorithm:

$${J}_{λ} ( θ ) = {\sum }_{u = 1}^{U} \{ log [ p ( {w}^{u} ) {p}_{θ} ( {O}^{u} \vert {w}^{u} ) ] - λlog {max}_{v} [ p ( v ) {p}_{0} ( {O}^{u} \vert v ) ] \}$$

The iterations were implemented with two different orders of the approximated MMI algorithm's basic steps, approximation, and maximization. The approximation step consists of performing recognition on the training set, in order to obtain the Bᵥ sets, and using the sets to calculated the approximated MMI objective function J_{λ}(θ). The maximization step consists of maximizing the objective function J_{λ}(θ) according to the re-estimation formula. The following orders were tested:

1. Applying Approximation and Maximization successively.

2. Applying one iteration of Approximation and then several iterations of Maximization.

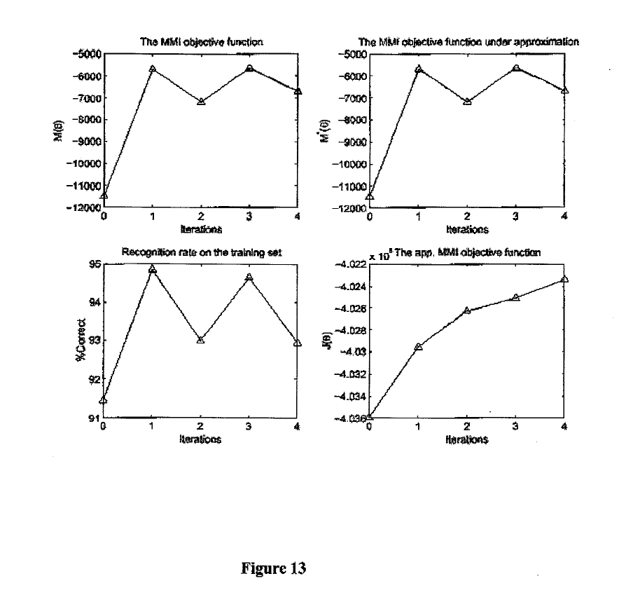

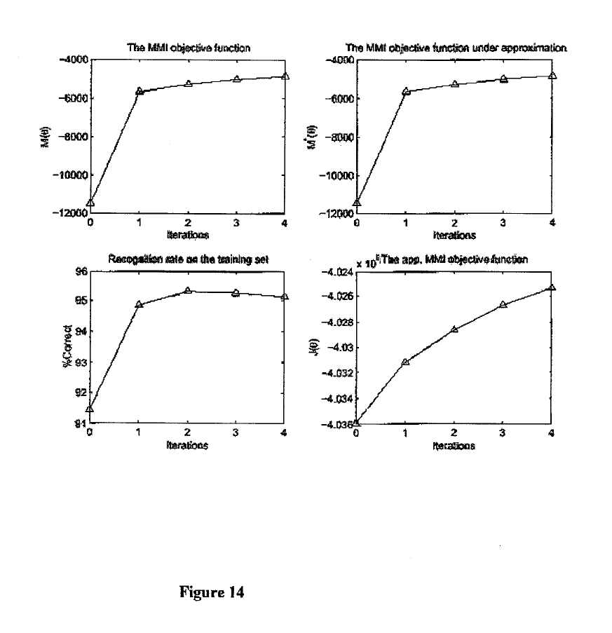

FIG. 13 shows the evolution of the above criteria along four iterations of the algorithm, where iterations were implemented in the first order with λ=0.5. Each iteration in the graph represents one iteration of Approximation followed by one iteration of Maximization. The zero-th iteration represents the values of the criteria before the first iteration of the algorithm was implemented. It is possible to see that no improvement was obtained after the first iteration, other than a consistent growth in the algorithm's objective function. FIG. 14 shows the corresponding evolution, where iterations were implemented in the second order. It is possible to see that a growth in all the objective functions was obtained, thereby showing that the assumptions made in the derivation of the maximization formulas actually hold. The relative error of the approximation of the MMI objective function was only 0.1%.

The best result that was yielded by the algorithm was a recognition rate of 92.16% on the test set. Such a result is equal to a reduction of 31% in the error rate, in comparison to the ML baseline. The result was obtained by applying two iterations of Maximization with λ=0.65. Table 1 summarizes the results obtained by the algorithm on the TIDIGITS database. The iteration columns in the table represent Maximization iterations.

TABLE 1
Summary of the results on the TIDIGITS database

| | Recognition rate | | | |
|---|---|---|---|---|
| Recognition set | Baseline | 1^{st} iteration | 2^{nd} iteration | Improvement |
| Training set | 91.60 | 96.31 | 96.31 | 56% |
| Test set | 88.58 | 91.79 | 92.16 | 31% |

Another experiment was performed using the TIMIT database. The TIMIT corpus is a popular database used in the development and evaluation of phonetic based speech recognition systems. The TIMIT database contains a total of 6300 sentences, 10 sentences spoken by each of 630 speakers from 8 major dialect regions of the United States. 64 different phonemes are labeled in the database. In the experiments using the TIMIT corpus, however, the total number of phonemes was reduced to 39, according to the mapping proposed by K. F. Lessee, H -W Hon. in “Speaker-independent phone recognition using hidden Markov models,” IEEE Trans. on ASSP, 37(11):1641-1648, 1989.

The training set in the experiments, comprised all the si and sx sentences of the TIMIT training database (overall 3696 sentences). The sa sentences were not used since they contain only two different sentences spoken by all speakers, and therefore form a biased sample set. For the test set, the 192 sentences of the core test set proposed in the TIMIT documentation were used.

In the experiment, the same settings were used as those used by Kapadia, Valtchev, and Young in “MMI training for continuous phoneme recognition on the TIMIT database,” ICASSP 1993, volume 2, pages 491-493, 1993. The feature vector comprised 12 Mel-frequency cepstral coefficients, log energy coefficient and their corresponding delta coefficient (a total number of 26 features). The speech was analyzed at a 10 ms frame rate with a window size of 16 ms. Each phoneme was modeled by a HMM with 3 emitting states and output distributions of 8 mixture Gaussians with diagonal covariance matrices. The HMM topology was left to right with skips. The language model was a first order Markovian model (a bigram model). Transition probabilities of the given model were calculated using the training set. As in Kapadia et al, these probabilities were squared during recognition. Squaring the probabilities was empirically determined to improve performance.

Training of the baseline (ML) models was done in the following steps: single mixture models were obtained by implementing three iterations of the segmental k-means algorithm, and six iterations of the Baum-Welch algorithm. Mixtures were incremented gradually; in each step the mixture with the highest weight was split, and the resultant model was trained using 6 iterations of the Baum-Welch algorithm. The split was performed by copying the mixture with the highest weight, dividing the weights of both copies by 2, and finally perturbing the means by plus and minus 0.2 the standard deviations.

Performance was evaluated using the following two expressions:

$$\% Correct = \frac{H}{N} \times 100 \%$$

$$Accuracy = \frac{H - I}{N} \times 100 \%$$

where N is the total number of phonemes in the transcription files, H is the number of phonemes correctly recognized, and I is the number of insertions.

The performance obtained by the baseline (ML) system was: % Correct=65.60%, Accuracy=61.52%.

The Approximation step of the algorithm was implemented by Viterbi recognition using the phoneme boundaries given in the transcription. The following observations coincide with the results obtained on the TIDIGITS task. The mixture algorithm did not yield an improvement in the performance. Estimating the entire parameter set yielded better results than estimating only a part of it. Successive Approximation, Maximization iterations did not yield an improvement in the error rate. However, more than one iteration of Maximization did yield an improvement.

Best results obtained on the TIDIGITS task were: % Correct—67.23%, Accuracy=63.59%, i.e. a reduction of 4.7% in the error of the % Correct, and of 5.4% in the error of the Accuracy. These results were obtained by implementing one iteration of Approximation, and two iterations of Maximization with λ=0.3 for all phonemes. This value was chosen by optimizing λ according to the recognition rate on the test set.

Optimization of a parameter according to the performance on the test set is not feasible in a realistic situation, since the test set is not known to the designer of the system. The following experiments were performed to find the values of the parameter without using the test set:

Experiment 1

Choosing a Different Value of λ for Each Phoneme

The value was chosen by optimizing the following criterion using a grid search. The criterion was the percentage of correct recognitions of the chosen phoneme in the training set, where recognition was performed only on the segments labeled as the current phoneme.

Experiment 2

Taking a Different Value of λ for Each Utterance u in the Training Set

The value was calculated using the following formula:

$$λ ( u ) = α + β \frac{1}{{T}^{u}} ( log {max}_{v} {p}_{θ} ( {O}^{u} \vert v ) - log {p}_{θ} ( {O}^{u} \vert {w}^{u} ) )$$

where α and β are two positive constants. This function resembles a function used in the corrective training algorithm. The motivation behind using it is to give a smaller weight to outliers.

The TIMIT database experiments did not outperform the experiments reported earlier on the TIDIGIT database. Experiment 1, however, led to a simple rule for the choice of λ, that was later used in the word-spotting experiments. The rule is to take λ to be half the value in which variances start to become negative.

The following conclusions can be deduced from the results of the experiments. Changing λ from 0 to 0.3 showed a monotonic increase in the recognition performance. The increase demonstrates the ability of the algorithm to improve recognition performance. The best improvement, however, was not a significant one. Kapadia et al reported an decrease of 13% in the error rate using the MMI algorithm in a similar task.

The difference between the major improvement obtained on the TIDIGITS database and the minor improvement obtained on the TIMIT database could be due to the nature of the databases. In the TIMIT database, the baseline recognition rate is relatively low. The low baseline recognition rate yields the negative sums in the parameter set estimation formulas and may cause a major shift in the parameters in comparison to their ML values. Another disadvantage of the TIMIT database is that the recognition rate is very different between the phonemes. The recognition rate varies between more than 90% for the best phonemes, and less than 40% for the worse ones. Thus a constant value of λ can yield an improvement for a few phonemes, but can be destructive for other ones. Different values of λ were therefore used for different phonemes. However, a rule for the choice of these parameters was not found. The optimization done in Experiment 1 did not yield an improvement. The lack of improvement may result from the fact that each phoneme was trained separately, so the mutual influence between the training of different phonemes was not taken into account. However, a joint grid search of the parameters of all the phonemes is not feasible, due to its high computational cost. Another reason can be the nature of the criterion used in Experiment 1. The criterion was used due to the relative simplicity of its computation. The iteration columns represent Maximization iterations.

Table 2 summarizes the results obtained by the algorithm on the TIMIT database.

TABLE 2
Summary of the results on the TIMIT database

| | Recognition rate | | | |
|---|---|---|---|---|
| Criterion | Baseline | 1^{st} iteration | 2^{nd} iteration | Improvement |
| % Correct | 65.60 | 67.01 | 67.23 | 4.7% |
| Accuracy | 61.52 | 62.97 | 63.59 | 5.4% |

The following conclusions were reached for the experiments conducted with both the TIDIGITS and TIMIT databases.

The relative difference between the MMI objective function and its approximated value was only 0.1%.

The maximization process, though not proven analytically, does yield growth in the algorithm's objective function as well as in the MMI objective function.

The best way to implement the algorithm is to use one iteration of Approximation and then one or two iterations of Maximization and not use Approximation and Maximization successively.

The question of how to find the optimal value of λ still remains open. In experiments a cross validation or a sub-optimal empirical rule were used.

A significant improvement (of 31%) was observed in the digit recognition task. A less significant improvement (of about 5%) was observed in the phoneme recognition task. This is due to the variance in the recognition rate across phonemes and to the sub-optimality of the choice of λ.

Experiments were also performed for the word-spotting task. The Road Rally (RDRALLY1) Corpora by NIST “The Road Rally Word-Spotting Corpora (RDRALLY1),” NIST Speech Disc6-1.1, September 1991 was used for both training and testing the word-spotter. The Road Rally corpora consist of two separate databases, Stonehenge and Waterloo, with 20 identified KWs. The Stonehenge corpus was collected from subjects using telephone handsets which were modified to contain a high quality microphone. The speech was filtered using a 300 Hz to 3300 Hz PCM FIR bandpass filter to simulate telephone bandwidth quality. The corpus consists of 80 speakers (28 females, 52 males) and contains three different styles of speech data: a read paragraph, conversational speech, KW dictation. The Waterloo corpus was collected from subjects using conventional telephones and dialed up telephone lines in the Massachusetts area. The speech was also filtered using the Stonehenge 300 Hz to 3300 Hz PCM FIR bandpass filter. The corpus consists of 56 speakers (28 females, 28 males) each reading the same paragraph. The speech waveform files contain 16-bit, 10 kHz sampled speech waveform data. Transcription files contain KW locations in terms of waveform data samples. Non-KW speech is not transcribed.

From these corpora, a few different sets of training and test sets were selected and examined.

Initially, experiments were performed using the Road Rally database on the baseline word-spotting system described above. The first goal of the baseline system was to be able to compare the results to the results obtained by others, such as Herbert Gish and Kenney Ng in “A segmental speech model with application to word spotting,” ICASSP 93, volume 2, pages 447-50, 1993, and R. C. Rose in “Discriminant word-spotting techniques for rejecting non-vocabulary utterances in unconstrained speech,” Proc. ICASSP 92, volume 2, pages 105-108, March 1992.

In order to perform the comparison, the experiments were performed using the same training and test sets as used by Gish et al and Rose. The training set was consisted of 28 Waterloo male speakers (speakers wm29-wm56), the test database was consisted of 10 Stonehenge male speakers (speakers sm33c-sm41c,sm43c).

Two different feature vectors were examined: Mel-frequency cepstral coefficients c1-c12+energy with their delta (26 features), and Mel-frequency cepstral coefficients c1-c10+delta coefficients Δc0-Δc10 (21 features).

In both cases, the speech data was analyzed at a 10 ms frame rate and a 25 ms window. Furthermore, mean normalization was applied to the feature vectors of each speech file separately.

Each KW was modeled by a left-to-right HMM with 18 emitting states and no skips. Other HMM topologies were tested as well, including the choice of a different number of emitting states per KW according to its number of phonemes. This, however, did not improve the performance. Gaussian mixture distributions were assumed for the emitting states, mixtures of 1-3 components were tested. The KW models were trained over the KW utterances in the training set. Initialization was implemented using three iterations of the segmental k-means algorithm. ML training was implemented using seven iterations of the Baum-Welch algorithm, while in multiple mixture models, the number of mixtures was incremented gradually (as described for the TIMIT database experiments).

Non-KW speech was modeled by a single filler model, which was trained over the non-KW parts of the training database. The model used was a HMM with one emitting state with 50 component Gaussian mixture distribution. The entire model (all 50 mixtures) was initialized using three iterations of the segmental k-means algorithm, and re-estimated using seven iterations of the Baum-Welch algorithm.

The spotter was operated in the following steps:

1. The KW+filler Viterbi recognizer was implemented using a word network with all 20 KWs and the filler model, with equal transition probabilities between them. The recognizer output was the transcription (putative hits) and its corresponding scores S_{KW}, which was the average log likelihood per frame.

2. The filler only recognizer was implemented in a similar way. The filler only recognizer word network consisted solely of the filler model. Its output was the score S_{F}.

3. A final score was given to each putative hit, according to S_{LR}S_{KW}−S_{F}. The final score was compared to a threshold, according to which the putative hits were reported as hits or false alarms.

Performance evaluation is done as follows. The putative hits are first ordered by score from best to worst across all test sentences for each individual KW. Then a tally is made of the number of true hits as the 1^{st}, 2^{nd}, etc. false alarm for each KW is encountered. At each false alarm level, the tallies are added across KWs and expressed as a percentage of the total number of KW examples in the test data. False alarm levels are given in terms of false alarms per KW per hour (fa/kw/hr).

In addition, the NIST figure of merit is calculated by averaging the detection rates up to 10 fa/kw/hr.

Table 3 summarizes the results obtained for the different parameterizations and various number of mixture components in KW model states. Detection rate results are given at the first two false alarms and at around 10 fa/kw/hr.

TABLE 3
Baseline spotter results with different parameterizations and
mixtures per emitting state.

| | No. of | | fa/kw/hr | | |
|---|---|---|---|---|---|
| Parameterization | mix | FOM | 1.1 | 3.4 | 10.3 |
| (c₁-c₁₂,e) + (Δc₁-Δc₁₂,Δe) | 1 | 68.00 | 56.5 | 66.6 | 75.7 |
| | 2 | 67.85 | 57.0 | 67.8 | 76.7 |
| | 3 | 68.60 | 58.2 | 68.4 | 75.9 |
| (c₁-c₁₀) + (Δc₀-Δc₁₀) | 1 | 71.31 | 57.5 | 71.1 | 80.0 |
| | 2 | 69.63 | 58.0 | 68.4 | 77.2 |
| | 3 | 67.28 | 55.7 | 65.8 | 75.4 |

As seen in table 3, best results were obtained with the second type of feature vector, and with a single mixture output probability. These were chosen to be the settings in all further word-spotting experiments.

After determining settings on the baseline word-spotter, experiments were performed on the word-spotting system according to the embodiments described above. A first experiment was conducted using the same training and test sets as in the baseline system (28 Waterloo male speakers for training, 10 Stonehenge male speakers for testing). A single iteration of the discriminative algorithm was applied, with variant values of the parameter λ. The two variants of the algorithm were tested. The second variant was implemented taking into account 2,4, . . . , 20 false alarms per KW per hour (fa/kw/hr).

The conclusions from the first experiments are:

1. The first variant (taking into account all false alarms) always outperformed the second variant. Subsequently, only the first variant was used.

2. No significant improvement was seen in the detection rate for the first 10 fa/kw/hr, or in the figure of merit (FOM). Yet, the overall number of false alarms was reduced drastically (from 830 to 768 with λ=0.1). This result, however, does not improve the system's performance, since the false alarms removed had very low score, and could have been discarded using the usual scoring procedure.

After obtaining the above results, a second experiment was conducted to test the algorithm on the same database used for training. The λ parameter was optimized according to the FOM on each word separately using a grid search. The experiment yielded a significant improvement in the average FOM, from 82.99% to 87.3%. However, these models did not yield an improvement on the test set. This result indicates that the algorithm did cause a separation between the KWs and their confusable utterances observed in the training set, thus yielding the improvement in the FOM. However, since all the speakers in the training set spoke the same text, the training set did not contain the same confusable utterances that appeared in the test set, therefore no improvement was obtained on the test set.

Following the above hypothesis, two further experiments were conducted, using a training set that is richer in confusions.

The third experiment used the Augmented male database, recommended in the Road Rally documentation. The training set contained the paragraph read by the Waterloo speakers (speakers wm29-wm56), and conversation by the male Stonehenge speakers sm03-sm10,sm13-sm16 (91 minutes of speech, containing 2999 KW utterances). The test set consisted of the conversations by the Stonehenge speakers sm33-sm43, sm49-sm59 (51 minutes of speech, containing 825 KW utterances). The average FOM obtained after ML estimation of the models was: 75.44%. One iteration of the discriminative algorithm was implemented with different values of λ. Optimizing λ according to the FOM of each KW separately raised the FOM to 77.00%. It should be noted that in a practical situation the test database is not known to the designer of the system, so the parameters can not be optimized according to it. The empirically derived rule described for the TIMIT database was used, which does not involve the test set in the choice of λ. The rule is: for each KW, set λ to half the maximal value for which variances are still positive. Using the empirically derived rule, the FOM reached the value of 75.95%.

The fourth experiment was performed using only the conversational speech data of the Stonehenge database, of both male and female speakers. The training set comprised the Stonehenge speakers sf01-sf02,sf11-sf12,sf42,sf44-sf48,sm03-sm16,sm49-sm59 (85 minutes of speech, containing 1313 KW utterances). The test set comprised the Stonehenge speakers sf58,sf60-sf64,sm33-sm41,sm43 (39 minutes of speech, containing 617 KW utterances). The average FOM obtained after ML estimation of the models was 56.76%. Optimizing λ according to the FOM in the test set of each KW separately raised the FOM to 63.70%. Taking λ to be half the maximal value for which variances are still positive raised the FOM to 61.38% (1^{st} rule in Table 4). Similarly, taking λ to be 0.7 of the maximal value yielded a FOM of 62.74% (2^{nd} rule in Table 4), and taking it to be 0.9 of the maximal values yielded a FOM of 64.16% (3^{rd} rule in Table 4). This is the best relative improvement obtained by the algorithm on a word-spotting task.

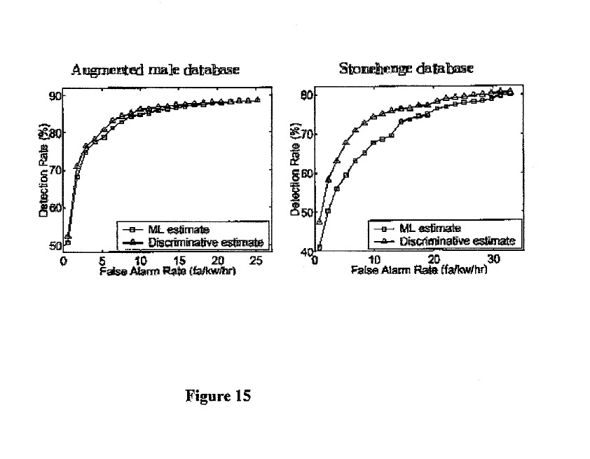

FIG. 15 illustrates the improvement in the ROC for the two experiments described above. Table 4 summarizes the results of the word-spotting experiments. The improvement in the Stonehenge database is much more significant then the one in the Augmented male database because the Augmented male database contains sentences from the Waterloo database, which contain a small number of confusable utterances.

TABLE 4
Summary of the results in the word-spotting tasks

| | FOM | | | | |
|---|---|---|---|---|---|
| Database | Baseline | Optimized λ | 1^{st} rule | 2^{nd} rule | 3^{rd} rule |
| Augmented | 75.44 | 77.00 | 75.95 | 76.22 | 75.87 |
| male | | | | | |
| Stonehenge | 56.76 | 63.70 | 61.38 | 62.74 | 64.16 |

The conclusions reached from the experiments conducted on word-spotting tasks are as follows. In the word-spotting case, the algorithm has two variants, of which the first one was found to be superior. First experiments were aimed to find appropriate training and test sets that will give a good representation of confusable words.

After the training and test databases were determined the discriminative algorithm was implemented. An improvement in performance from FOM of 56.76 to FOM of 64.16 was observed.

In summary, the above embodiments describe a new system and method for discriminative training. A new estimation criterion referred to as the approximated MMI criterion and an optimization technique similar to the EM algorithm were described. Unlike existing discriminative algorithms, the training process using the approximated MMI criterion algorithm can be implemented by a simple modification of the Baum-Welch algorithm.

The training algorithm has two major steps: Approximation, which is the derivation of the algorithm's criterion, and Maximization, which is similar to the EM maximization. It was seen in experiments that the approximation yields a small relative error (0.1%). The maximization process showed to yield a monotonic growth in the objective function along the iterations. Monotonic growth in the objective function is a desirable property proven for the EM algorithm, and was empirically found to be true in the given case of the algorithm.

Three tasks were tested: isolated digit recognition in a noisy environment, phoneme recognition, and word spotting. In the digit recognition task a reduction of 31% in the error rate was observed. In the phoneme recognition task the reduction was only of 5%. The phoneme recognition results may be due to the low baseline recognition rate, and to the variance in recognition rates across phonemes.

The algorithm can be adjusted to a word-spotting task. The choice of a training set that is rich in confusable utterances was found critical for the success of the algorithm. The best result for the word-spotting task was a reduction of 16% in the error rate.

The abovedescribed embodiments provide a needed alternative to training methods currently in use. The approximated MMI criterion can be integrated into pattern recognition systems to provide an easily calculated set of parameters that yields better performance than the existing ML method. The effectiveness of these embodiments has been demonstrated for the example of speech recognition systems, and they are applicable to a wide variety of statistical pattern recognition systems. The approximated MMI criterion works well for statistical pattern recognition systems where the statistical model contains hidden or incomplete data.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

We claim:

1. A parameter estimator for estimating a set of parameters for pattern recognition, said parameter estimator comprising:
a recognizer for receiving a training set having members and performing recognition on said members using a current set of parameters and a predetermined group of elements,
a set generator associated with said recognizer for generating at least one equivalence set comprising recognized ones of said members,
a target function determiner associated with said set generator for calculating from at least one of said equivalence sets a target function using said set of parameters, and
a maximizer associated with said target function determiner for updating said set of parameters to maximize said target function.

2. A parameter estimator according to claim 1, wherein said target function comprises a summation, over the elements of said predetermined group of elements, of a difference between:
a first summation of logarithms of probability density functions as a function of said set of parameters, and
a second summation, of logarithms of probability density functions as a function of said set of parameters, multiplied by a discrimination rate, said discrimination rate being variable between zero and one.

3. A parameter estimator according to claim 2, wherein said target function comprises
$${\sum }_{v = 1}^{V} \{ {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) \}$$
wherein v is an element of said predetermined group of elements,
V is the number of elements of said predetermined group of elements,
u is the index of a member of said training set,
Aᵥ is a set of indices of members of said training set corresponding to element v,
Bᵥ is a set of indices of members of said training set corresponding to an equivalence set associated with element v,
O^{u} is a u^{th} member of said training set,
λ is said discrimination rate,
θ is said set of parameters, and
p_{θ}(.|v) is a predetermined probability density function of element v using said set of parameters.

4. A parameter estimator according to claim 1, further comprising an initial estimator associated with said recognizer for calculating an initial estimate of said parameter set.

5. A parameter estimator according to claim 4, wherein said initial estimate comprises a maximum likelihood estimate.

6. A parameter estimator according to claim 3, further comprising a discrimination rate tuner associated with said target function determiner for tuning said discrimination rate within said range.

7. A parameter estimator according to claim 6, wherein said discrimination rate tuner is operable to tune said discrimination rate to a constant value for all members of said training set.

8. A parameter estimator according to claim 6, wherein, for a given member of said training set, said discrimination rate tuner is operable to tune said discrimination rate to a respective discrimination rate level associated with said member.

9. A parameter estimator according to claim 6, wherein said discrimination rate is tunable so as to optimize said parameter set according to a predetermined optimization criterion.

10. A parameter estimator according to claim 1, wherein said maximizer is further operable to feed back said updated parameter set to said recognizer.

11. A parameter estimator according to claim 10, wherein said parameter estimator comprises an iterative device.

12. A parameter estimator according to claim 1, further comprising a parameter outputter associated with said maximizer and a statistical pattern recognition system for outputting at least some of said updated parameter set.

13. A parameter estimator according to claim 12, wherein said statistical pattern recognition system comprises a speech recognition system.

14. A parameter estimator according to claim 13, wherein said speech recognition system comprises a word-spotting system.

15. A parameter estimator according to claim 12, wherein said statistical pattern recognition system includes one of a group comprising: image recognition, decryption, communications, sensory recognition, optical, optical character recognition (OCR), natural language processing (NLP), gesture and object recognition (for machine vision), text classification, and control systems.

16. A parameter estimator according to claim 3, wherein said maximizer comprises an iterative device comprising:
an auxiliary function determiner for forming an auxiliary function associated with said target function from a current estimate of said set of parameters, and
an auxiliary function maximizer for updating said set of parameters to maximize said auxiliary function.

17. A parameter estimator according to claim 16, wherein said auxiliary function comprises a summation, over the elements of said predetermined group of elements, of a difference between:
a first summation of conditional expected value functions as a function of said set of parameters, and
a second summation, of conditional expected value functions as a function of said set of parameters, multiplied by a discrimination rate, said discrimination rate being variable between zero and one.

18. A parameter estimator according to claim 17, wherein said auxiliary function comprises
$${\sum }_{v = 1}^{V} \{ {\sum }_{u ∈ {A}_{v}} {E}_{{θ}^{( l )}} \{ log {f}_{X} ( {x}^{u} ; θ ) \vert {y}^{u} \} - {λ \sum }_{u ∈ {B}_{v}} {E}_{{θ}^{( l )}} \{ log {f}_{X} ( {x}^{u} ; θ ) \vert {y}^{u} \} \}$$
wherein l is a step number,
θ^{(l)} is an estimate of said set of parameters at step l,
y^{u} is a u^{th} member of said training set,
x^{u} is a u^{th} member of a second data set associated with said training set,
f_{X}(x^{u};θ) is a predetermined probability density function of data member x^{u} of said second data set using said set of parameters, and
E_{θ}_{^{(l)}}{.|y^{u}} is a conditional expected value function conditional upon member y^{u} of said training set using said estimate of said set of parameters at step l.

19. A parameter estimator according to claim 18, wherein said second data set comprises a complete data set.

20. A parameter estimator according to claim 18, further comprising an initial estimator associated with said maximizer for calculating an initial estimate of said parameter set.

21. A parameter estimator according to claim 18, wherein said initial estimate comprises a maximum likelihood estimate.

22. A parameter estimator according to claim 1, wherein said statistical pattern recognition system comprises a speech recognition system, said members of said training set comprise utterances, and said predetermined group of elements comprises a predetermined vocabulary of words.

23. A parameter estimator according to claim 22, wherein said recognizer comprises a Viterbi recognizer.

24. A parameter estimator according to claim 1, wherein said parameters comprise parameters of a statistical model.

25. A parameter estimator according to claim 24, wherein said statistical model comprises a hidden Markov model (HMM).

26. A parameter estimator for estimating a set of parameters for word-spotting pattern recognition, said parameter estimator comprising:
a recognizer for receiving a training set, performing recognition on said training set using a current set of parameters and a predetermined group of elements, and providing recognized transcriptions of said training set,
a target function determiner associated with said recognizer for calculating from at least one of said recognized transcriptions a target function using said set of parameters, and
a maximizer associated with said target function determiner for updating said set of parameters to maximize said target function.

27. A parameter estimator according to claim 26, wherein said target function comprises a difference between:
a logarithm of a first probability density function as a function of said set of parameters, and
a logarithm of a second probability density function as a function of said set of parameters, multiplied by a discrimination rate, said discrimination rate being variable between zero and one.

28. A parameter estimator according to claim 27, wherein said target function comprises
log p_{θ}(O|W)−λ log p_{θ}(O|Ŵ)
wherein W is a possible transcription of said training set,
Ŵ is a recognized transcription of said training set,
O is said training set,
λ is said discrimination rate,
θ is said set of parameters, and
p_{θ}(.|.) is a predetermined probability density function using said set of parameters.

29. A parameter estimator according to claim 26, further comprising an initial estimator associated with said recognizer for calculating an initial estimate of said parameter set.

30. A parameter estimator according to claim 28, wherein said initial estimate comprises a maximum likelihood estimate.

31. A parameter estimator according to claim 27, further comprising a discrimination rate tuner associated with said target function determiner for tuning said discrimination rate within said range.

32. A parameter estimator according to claim 31, wherein said discrimination rate is tunable so as to optimize said parameter set according to a predetermined optimization criterion.

33. A parameter estimator according to claim 26, wherein said maximizer is further operable to feed back said updated parameter set to said recognizer.

34. A parameter estimator according to claim 33, wherein said parameter estimator comprises an iterative device.

35. A parameter estimator according to claim 26, further comprising a parameter outputter associated with said maximizer and a word-spotting pattern recognition system for outputting at least some of said updated parameter set.

36. A parameter estimator according to claim 27, wherein said maximizer comprises an iterative device comprising:
an auxiliary function determiner for forming an auxiliary function associated with said target function from a current estimate of said set of parameters, and
an auxiliary function maximizer for updating said set of parameters to maximize said auxiliary function.

37. A pattern recognizer for performing statistical pattern recognition upon an input sequence, said pattern recognizer being operable to transcribe said input sequence into an output sequence, said output sequence comprising elements from a predetermined group of elements, said pattern recognizer comprising:
a transcriber for performing said transcription according to a predetermined statistical model having a set of parameters, and
a parameter estimator for providing said set of parameters, said parameter estimator comprising:
a recognizer for receiving a training set having members and performing recognition on said members using a current set of parameters and said predetermined group of elements,
a set generator associated with said recognizer for generating at least one equivalence set comprising recognized ones of said members,
a target function determiner associated with said set generator for calculating from at least one of said equivalence sets a target function using said set of parameters, and
a maximizer associated with said target function determiner for updating said set of parameters to maximize said target function.

38. A pattern recognizer according to claim 37, wherein said target function comprises a summation, over the elements of said predetermined group of elements, of a difference between:
a first summation of logarithms of probability density functions as a function of said set of parameters, and
a second summation, of logarithms of probability density functions as a function of said set of parameters, multiplied by a discrimination rate, said discrimination rate being variable between zero and one.

39. A pattern recognizer according to claim 38, wherein said target function comprises
$${\sum }_{v = 1}^{V} \{ {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) \}$$
wherein v is an element of said predetermined group of elements,
V is the number of elements of said predetermined group of elements,
u is the index of a member of said training set,
Aᵥ is a set of indices of members of said training set corresponding to element v,
Bᵥ is a set of indices of members of said training set corresponding to an equivalence set associated with element v,
O^{u} is a u^{th} member of said training set,
λ is said discrimination rate,
θ is said set of parameters, and
p_{θ}(.|v) is a predetermined probability density function of element v using said set of parameters.

40. A pattern recognizer according to claim 37, further comprising an initial estimator associated with said recognizer for calculating an initial estimate of said parameter set.

41. A pattern recognizer according to claim 37, wherein said maximizer is further operable to feed back said updated parameter set to said recognizer.

42. A pattern recognizer according to claim 41, wherein said parameter estimator comprises an iterative device.

43. A pattern recognizer according to claim 39, wherein said maximizer comprises an iterative device comprising:
an auxiliary function determiner for forming an auxiliary function associated with said target function from a current estimate of said set of parameters, and
an auxiliary function maximizer for updating said set of parameters to maximize said auxiliary function.

44. A pattern recognizer according to claim 40, wherein said auxiliary function comprises a summation, over the elements of said predetermined group of elements, of a difference between:
a first summation of conditional expected value functions as a function of said set of parameters, and
a second summation, of conditional expected value functions as a function of said set of parameters, multiplied by a discrimination rate, said discrimination rate being variable between zero and one.

45. A pattern recognizer according to claim 44, wherein said auxiliary function comprises
$${\sum }_{v = 1}^{V} \{ {\sum }_{u ∈ {A}_{v}} {E}_{{θ}^{( l )}} \{ log {f}_{X} ( {x}^{u} ; θ ) \vert {y}^{u} \} - λ {\sum }_{u ∈ {B}_{v}} {E}_{{θ}^{( l )}} \{ log {f}_{X} ( {x}^{u} ; θ ) \vert {y}^{u} \} \}$$
wherein l is a step number,
θ^{(l)} is an estimate of said set of parameters at step l,
y^{u} is a u^{th} member of said training set,
x^{u} is a u^{th} member of a second data set associated with said training set,
f_{X}(x^{u};θ) is a predetermined probability density function of data member x^{u} of said second data set using said set of parameters, and
E_{θ}_{^{(l)}}{.|y^{u}} is a conditional expected value function conditional upon member y^{u} of said training set using said estimate of said set of parameters at step l.

46. A pattern recognizer according to claim 37, wherein said statistical pattern recognition comprises speech recognition.

47. A pattern recognizer according to claim 46, wherein said members of said training set comprise utterances and said predetermined group of elements comprises a predetermined vocabulary of words.

48. A pattern recognizer according to claim 47, wherein said recognizer comprises a Viterbi recognizer.

49. A pattern recognizer according to claim 37, wherein said statistical pattern recognition system includes one of a group comprising: image recognition, decryption, communications, sensory recognition, optical character recognition (OCR), natural language processing (NLP), gesture and object recognition (for machine vision), text classification, and control systems.

50. A pattern recognizer according to claim 37, wherein said statistical model comprises a hidden Markov model (HMM).

51. A pattern recognizer according to claim 37, wherein said input sequence comprises a continuous sequence.

52. A pattern recognizer according to claim 37, wherein said output sequence comprises a continuous sequence.

53. A speech recognizer for performing statistical speech processing upon an input sequence of utterances, said speech recognizer being operable to transcribe said input sequence into an output sequence, said output sequence comprising words from a predetermined vocabulary, said speech recognizer comprising:
a transcriber for performing said transcription according to a predetermined statistical model having a set of parameters, and
a parameter estimator for providing said set of parameters, said parameter estimator comprising:
a recognizer for receiving a training set having utterances and performing recognition on said utterances using a current set of parameters and said predetermined vocabulary,
a set generator associated with said recognizer for generating at least one equivalence set comprising recognized ones of said utterances,
a target function determiner associated with said set generator for calculating from at least one of said equivalence sets a target function using said set of parameters, and
a maximizer associated with said target function determiner for updating said set of parameters to maximize said target function.

54. A speech recognizer according to claim 53, wherein said statistical model comprises a hidden Markov model (HMM).

55. A speech recognizer according to claim 53, wherein said target function comprises a summation, over the elements of said predetermined group of elements, of a difference between:
a first summation of logarithms of probability density functions as a function of said set of parameters, and
a second summation, of logarithms of probability density functions as a function of said set of parameters, multiplied by a discrimination rate, said discrimination rate being variable between zero and one.

56. A speech recognizer according to claim 55, wherein said target function comprises
$${\sum }_{v - 1}^{V} \{ {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) \}$$
wherein v is a word of said predetermined vocabulary,
V is the number of elements of said predetermined group of elements,
u is the index of an utterance of said training set,
Aᵥ is a set of indices of utterances of said training set corresponding to word v,
Bᵥ is a set of indices of utterances of said training set corresponding to an equivalence set associated with word v,
O^{u} is a u^{th} utterance of said training set,
λ is said discrimination rate,
θ is said set of parameters, and
p_{θ}(.|v) is a predetermined probability density function of word v using said set of parameters.

57. A speech recognizer according to claim 53, further comprising an initial estimator associated with said recognizer for calculating an initial estimate of said parameter set.

58. A speech recognizer according to claim 53, wherein said maximizer is further operable to feed back said updated parameter set to said recognizer.

59. A speech recognizer according to claim 58, wherein said parameter estimator comprises an iterative device.

60. A speech recognizer according to claim 56, wherein said maximizer comprises an iterative device comprising:
an auxiliary function determiner for forming an auxiliary function associated with said target function from a current estimate of said set of parameters, and
an auxiliary function maximizer for updating said set of parameters to maximize said auxiliary function.

61. A speech recognizer according to claim 60, wherein said auxiliary function comprises a summation, over the elements of said predetermined group of elements, of a difference between:
a first summation of conditional expected value functions as a function of said set of parameters, and
a second summation, of conditional expected value functions as a function of said set of parameters, multiplied by a discrimination rate, said discrimination rate being variable between zero and one.

62. A speech recognizer according to claim 61, wherein said auxiliary function comprises
$${\sum }_{v = 1}^{V} \{ {\sum }_{u ∈ {A}_{v}} {E}_{{θ}^{( l )}} \{ log {f}_{X} ( {x}^{u} ; θ ) \vert {y}^{u} \} - λ {\sum }_{u ∈ {B}_{v}} {E}_{{θ}^{( l )}} \{ log {f}_{X} ( {x}^{u} ; θ ) \vert {y}^{u} \} \}$$
wherein l is a step number,
θ^{(l)} is an estimate of said set of parameters at step l,
y^{u} is a u^{th} utterance of said training set,
x^{u} is a u^{th} utterance of a second data set associated with said training set,
f_{X}(x^{u};θ) is a predetermined probability density function of data utterance x^{u} of said second data set using said set of parameters, and
E_{θ}_{^{(l)}}{.|y^{u}} is a conditional expected value function conditional upon utterance y^{u} of said training set using said estimate of said set of parameters at step l.

63. A speech recognizer according to claim 53, wherein said recognizer comprises a Viterbi recognizer.

64. A speech recognizer according to claim 53, further comprising a converter for converting said input sequence of utterances into a sequence of samples representing a speech waveform.

65. A speech recognizer according to claim 64, further comprising a feature extractor for extracting from said sequence of samples a feature vector for processing by said transcriber, and wherein a dimension of said feature vector is less than a dimension of said sequence of samples.

66. A speech recognizer according to claim 53, further comprising a language modeler, for providing grammatical constraints to said transcriber.

67. A speech recognizer according to claim 53, further comprising an acoustic modeler for embedding acoustic constraints into said statistical model.

68. A speech recognizer according to claim 53, wherein said input sequence comprises a continuous speech sequence.

69. A speech recognizer according to claim 53, wherein said output sequence comprises a continuous speech sequence.

70. A speech recognizer according to claim 53, wherein said utterances comprise keywords and non-keywords, and wherein said speech recognizer is further operable to identify said keywords within said input sequence.

71. A parameter estimator for estimating a set of parameters for pattern recognition, said parameter estimator comprising:
a recognizer for receiving a training set having members and performing recognition on said members using a current set of parameters and a predetermined group of elements,
a set generator associated with said recognizer for generating at least one equivalence set comprising recognized ones of said members,
a numerator calculator, associated with said set generator, operable to calculate, for a given parameter and a set of indices of training set members, a respective numerator accumulator,
a denominator calculator associated with said set generator, operable to calculate, for said given parameter and a set of indices of training set members, a respective denominator accumulator, and
an evaluator, associated with said numerator calculator and said denominator calculator, for calculating for said given parameter a quotient between
the difference between
a first numerator accumulator, calculated for said given parameter and a set of indices of training set members corresponding to a given element v, and
a second numerator accumulator, calculated for said given parameter and a set of indices of training set members corresponding to an equivalence set associated with element v, multiplied by a discrimination rate, and,
the difference between
a first denominator accumulator, calculated for said given parameter and said set of indices of training set members corresponding to element v, and
a second denominator accumulator, calculated for said given parameter and said set of indices of training set members corresponding to said equivalence set associated with element v, multiplied by a discrimination rate,
said discrimination rate being variable between zero and one.

72. A parameter estimator according to claim 71, wherein said parameters comprise parameters of a statistical model.

73. A parameter estimator according to claim 72, wherein said statistical model comprises a hidden Markov model (HMM).

74. A parameter estimator according to claim 72, wherein said statistical model includes one of a group comprising: Gaussian distribution, and Gaussian mixture distribution.

75. A parameter estimator according to claim 71, wherein said numerator calculator is operable to calculate said numerator accumulator for said given parameter in accordance with a maximum likelihood estimate of a numerator accumulator of said parameter.

76. A parameter estimator according to claim 71, wherein said quotient is
$$\frac{N ( b ) - λ {N}_{D} ( b )}{D ( b ) - λ {D}_{D} ( b )}$$
where b is said given parameter,
N(b) is said first numerator,
N_{D}(b) is said second numerator,
λ is said discrimination rate,
D(b) is said first denominator, and
D_{D}(b) is said second denominator.

77. A parameter estimator according to claim 71, wherein said denominator calculator is operable to calculate said denominator accumulator for said given parameter in accordance with a maximum likelihood estimate of a denominator accumulator of said parameter.

78. A method for estimating a set of parameters for insertion into a statistical pattern recognition process, said method comprising:
determining initial values for said set of parameters; and
performing an estimation cycle comprising:
receiving a training set having members;
performing recognition on said members using a current set of parameters and a predetermined group of elements;
generating at least one equivalence set comprising recognized members of said training set;
using said equivalence sets and said set of parameters to calculate a target function;
maximizing said target function with respect to said set of parameters;
updating said set of parameters to maximize said target function;
if said set of parameters satisfies a predetermined estimation termination condition, outputting said parameters and discontinuing said parameter estimation method; and
if said set of parameters does not satisfy a predetermined estimation termination condition, performing another estimation cycle.

79. A method for estimating a set of parameters according to claim 78, wherein said target function comprises a summation, over the elements of said predetermined group of elements, of a difference between:
a first summation of logarithms of probability density functions as a function of said set of parameters, and
a second summation, of logarithms of probability density functions as a function of said set of parameters, multiplied by a discrimination rate, said discrimination rate being variable between zero and one.

80. A method for estimating a set of parameters according to claim 79, wherein said target function comprises
$${\sum }_{v = 1}^{V} \{ {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) \}$$
wherein v is an element of said predetermined group of elements,
V is the number of elements of said predetermined group of elements,
u is the index of a member of said training set,
Aᵥ is a set of indices of members of said training set corresponding to element v,
Bᵥ is a set of indices of members of said training set corresponding to an equivalence set associated with element v,
O^{u} is a u^{th} member of said training set,
λ is said discrimination rate,
θ is said set of parameters, and
p_{θ}(.|v) is a predetermined probability density function of element v using said set of parameters.

81. A method for estimating a set of parameters according to claim 79, further comprising tuning said discrimination rate.

82. A method for estimating a set of parameters according to claim 78, further comprising providing at least some of said updated parameter set to a statistical pattern recognition process.

83. A method for estimating a set of parameters according to claim 82, wherein said statistical pattern recognition process comprises a speech recognition process.

84. A method for estimating a set of parameters according to claim 82, wherein said statistical pattern recognition process includes one of a group comprising: image recognition, decryption, communications, sensory recognition, optical, optical character recognition (OCR), natural language processing (NLP), gesture and object recognition (for machine vision), text classification, and control processes.

85. A method for estimating a set of parameters according to claim 78, wherein the step of maximizing said target function with respect to said set of parameters comprises:
performing a maximization cycle comprising:
using a current estimate of said set of parameters to calculate an auxiliary function associated with said target function;
maximizing said auxiliary function with respect to said set of parameters;
updating said set of parameters to maximize said target function;
if said set of parameters satisfies a predetermined maximization termination condition, outputting said parameters and discontinuing said parameter maximization; and
if said set of parameters does not satisfy a predetermined maximization termination condition, performing another maximization cycle.

86. A method for estimating a set of parameters according to claim 85, wherein said auxiliary function comprises a summation, over the elements of said predetermined group of elements, of a difference between:
a first summation of conditional expected value functions as a function of said set of parameters, and
a second summation, of conditional expected value functions as a function of said set of parameters, multiplied by a discrimination rate, said discrimination rate being variable between zero and one.

87. A method for estimating a set of parameters according to claim 86, wherein said auxiliary function comprises
$${\sum }_{v = 1}^{V} \{ {\sum }_{u ∈ {A}_{v}} {E}_{{θ}^{( l )}} \{ log {f}_{X} ( {x}^{u} ; θ ) \vert {y}^{u} \} - λ {\sum }_{u ∈ {B}_{v}} {E}_{{θ}^{( l )}} \{ log {f}_{X} ( {x}^{u} ; θ ) \vert {y}^{u} \} \}$$
wherein l is a step number,
θ^{(l)} is an estimate of said set of parameters at step l,
y^{u} is a u^{th} member of said training set,
x^{u} is a u^{th} member of a second data set associated with said training set,
f_{X}(x^{u};θ) is a predetermined probability density function of data member x^{u} of said second data set using said set of parameters, and
E_{θ}_{^{(l)}}{.|y^{u}} is a conditional expected value function conditional upon member y^{u} of said training set using said estimate of said set of parameters at step l.

88. A method for estimating a set of parameters according to claim 87, wherein said second data set comprises a complete data set.

89. A method for estimating a set of parameters according to claim 78, wherein said statistical pattern recognition process comprises a speech recognition process, said members of said training set comprise utterances, and said predetermined group of elements comprises a predetermined vocabulary of words.

90. A method for estimating a set of parameters according to claim 89, wherein said performing recognition on said members comprises performing Viterbi recognition on said members.

91. A method for estimating a set of parameters according to claim 78, wherein determining initial values for said set of parameters comprises performing maximum likelihood estimation to determine said initial values.

92. A method for estimating a set of parameters according to claim 78, wherein said statistical process uses a hidden Markov model (HMM).

93. A method for performing statistical pattern recognition upon an input sequence, thereby to transcribe said input sequence into an output sequence comprising elements from a predetermined group of elements, the method comprising the steps of:
receiving said input sequence;
estimating a set of parameters of a statistical model by:
determining initial values for said set of parameters; and
performing an estimation cycle comprising:
receiving a training set having members;
performing recognition on said members using a current set of parameters and said predetermined group of elements;
generating at least one equivalence set comprising recognized members of said training set;
using said equivalence sets and said set of parameters to calculate a target function;
maximizing said target function with respect to said set of parameters;
updating said set of parameters to maximize said target function;
if said set of parameters satisfies a predetermined estimation termination condition, discontinuing said parameter estimation; and
if said set of parameters does not satisfy a predetermined estimation termination condition, performing another estimation cycle;
transcribing said input sequence according to said statistical model having said estimated set of parameters.

94. A method for performing statistical pattern recognition according to claim 93, wherein said target function comprises a summation, over the elements of said predetermined group of elements, of a difference between:
a first summation of logarithms of probability density functions as a function of said set of parameters, and
a second summation, of logarithms of probability density functions as a function of said set of parameters, multiplied by a discrimination rate, said discrimination rate being variable between zero and one.

95. A method for performing statistical pattern recognition according to claim 94, wherein said target function comprises
$${\sum }_{v = 1}^{V} \{ {\sum }_{u ∈ {A}_{v}} log {p}_{θ} ( {O}^{u} \vert v ) - λ {\sum }_{u ∈ {B}_{v}} log {p}_{θ} ( {O}^{u} \vert v ) \}$$
wherein v is an element of said predetermined group of elements,
V is the number of elements of said predetermined group of elements,
u is the index of a member of said training set,
Aᵥ is a set of indices of members of said training set corresponding to element v,
Bᵥ is a set of indices of members of said training set corresponding to all equivalence set associated with element v,
O^{u} is a u^{th} member of said training set,
λ is said discrimination rate,
θ is said set of parameters, and
p_{θ}(.|v) is a predetermined probability density function of element v using said set of parameters.

96. A method for performing statistical pattern recognition according to claim 95, further comprising tuning said discrimination rate.

97. A method for performing statistical pattern recognition according to claim 93, wherein said statistical pattern recognition process comprises a speech recognition process.

98. A method for performing statistical pattern recognition according to claim 93, wherein said statistical pattern recognition process comprises one of said following types of processes: image recognition, decryption, communications, sensory recognition, optical, optical character recognition (OCR), natural language processing (NLP), gesture and object recognition (for machine vision), text classification, and control.

99. A method for performing statistical pattern recognition according to claim 93, wherein the step of maximizing said target function with respect to said set of parameters comprises:
performing a maximization cycle comprising:
using a current estimate said set of parameters to calculate an auxiliary function associated with said target function;
maximizing said auxiliary function with respect to said set of parameters;
updating said set of parameters to maximize said target function;
if said set of parameters satisfies a predetermined maximization termination condition, outputting said parameters and discontinuing said parameter maximization; and
if said set of parameters does not satisfy a predetermined maximization termination condition, performing another maximization cycle.

100. A method for performing statistical pattern recognition according to claim 99, wherein said auxiliary function comprises a summation, over the elements of said predetermined group of elements, of a difference between:
a first summation of conditional expected value functions as a function of said set of parameters, and
a second summation, of conditional expected value functions as a function of said set of parameters, multiplied by a discrimination rate, said discrimination rate being variable between zero and one.

101. A method for performing statistical pattern recognition according to claim 100, wherein said auxiliary function comprises
$${\sum }_{v = 1}^{V} \{ {\sum }_{u ∈ {A}_{v}} {E}_{{θ}^{( l )}} \{ log {f}_{X} ( {x}^{u} ; θ ) \vert {y}^{u} \} - λ {\sum }_{u ∈ {B}_{v}} {E}_{{θ}^{( l )}} \{ log {f}_{X} ( {x}^{u} ; θ ) \vert {y}^{u} \} \}$$
wherein l is a step number,
θ^{(l)} is an estimate of said set of parameters at step l,
y^{u} is a u^{th} member of said training set,
x^{u} is a u^{th} member of a second data set associated with said training set,
f_{X}(x^{u};θ) is a predetermined probability density function of data member x^{u} of said second data set using said set of parameters, and
E_{θ}_{^{(l)}}{.|y^{u}} is a conditional expected value function conditional upon member y^{u} of said training set using said estimate of said set of parameters at step l.

102. A method for performing statistical pattern recognition according to claim 93, wherein said statistical pattern recognition comprises a speech recognition, said members of said training set comprise utterances, and said predetermined group of elements comprises a predetermined vocabulary of words.

103. A method for performing statistical pattern recognition according to claim 102, wherein performing recognition on said members comprises performing Viterbi recognition on said members.

104. A method for performing statistical pattern recognition according to claim 102, wherein transcribing said input sequence comprises performing Viterbi recognition upon said input sequence.

105. A method for performing statistical pattern recognition according to claim 93, wherein determining initial values for said set of parameters comprises performing maximum likelihood estimation to determine said initial values.

106. A method for performing statistical pattern recognition according to claim 93, wherein said statistical model comprises a hidden Markov model (HMM).

107. A method for performing statistical pattern recognition according to claim 93, wherein said input sequence comprises a continuous sequence.
